(19) United States
(12) Patent Application Publication
(10) Pub. No.: US 2025/0284280 A1
(43) Pub. Date: Sep. 11, 2025

(54) ADAPTOR

(71) Applicant: FQ IP AB, Mölndal (SE)

(72) Inventor: Per Augustsson, Mölndal (SE)

(73) Assignee: FQ IP AB, Mölndal (SE)

(21) Appl. No.: 19/216,069

(22) Filed: May 22, 2025

Related U.S. Application Data
(63) Continuation-in-part of application No. 18/417,839, filed on Jan. 19, 2024.
Application No. 18/417,839 is a continuation-in-part of application No. PCT/SE2023/050088, filed on Feb. 2, 2023.
Application No. PCT/SE2023/050088 is a continuation-in-part of application No. 18/122,912, filed on Mar. 17, 2023.

(30) Foreign Application Priority Data
Feb. 4, 2022 (SE) 2250112-6

(51) Int. Cl. G05D 1/225; G05D 105/28; G05D 107/70

(52) U.S. Cl. CPC G05D 1/225; G05D 2105/28; G05D 2107/70

(57) ABSTRACT

A self-propelled adaptor unit for use in the intralogistics system. The self-propelled adaptor unit comprising a motor, and at least one drive wheel connected to the motor for propelling the self-propelled adaptor unit. The self-propelled adaptor unit further comprises a first mechanical connection configured to connect to a mechanical connection of a load bearing unit, such that a first mechanical interconnection can be created between the self-propelled adaptor unit and the load bearing unit. The self-propelled adaptor unit further comprises a computer connected to the motor and the at least one drive wheel, the computer comprises a receiver for receiving instructions from a self-propelled autonomous or remote-controlled guide unit for controlling the motor.

### FIELD OF THE INVENTION

This invention relates to an adaptor unit for self-propelled autonomous or remote-controlled guide units in an intra-logistic system, as well as intra-logistic systems making used of such an adaptor unit.

### BACKGROUND ART

All forms of handling of goods, material or items of manufacturing requires intralogistics, i.e. logistics within some confined area such as a factory, warehouse or yard. Traditionally, forklifts have been the dominating vehicle both for transporting pallets of smaller items and larger items individually. Forklifts however have some limitations and are being replaced in many environments by manual carts pushed by human workers. The carts are less likely to cause accidents and are much more adaptable to specific uses or sizes of the transported items. However, the manual carts also have drawbacks, such as limitations of the maximum load capacity that a human operator can handle, and in that the logistic system becomes relatively labour intensive. Also, the carts are sometimes incompatible with logistic systems which are based on pallets and forklifts.

### SUMMARY

It is an object to mitigate, alleviate or eliminate one or more of the above-identified deficiencies in the art and disadvantages singly or in any combination.

According to one aspect, a system for intralogistics is provided. The system comprises a load bearing unit, a self-propelled adaptor unit and a self-propelled autonomous or remote-controlled guide unit. The load bearing unit comprises a mechanical connection, at least one support element configured to be placed at least partially in contact with a load, and at least one wheel enabling the load bearing unit to be rolled on a floor surface and/or the mechanical connection enabling the load bearing unit to be lifted from a floor surface by the self-propelled adaptor unit. The self-propelled adaptor unit comprises a motor and at least one drive wheel connected to the motor for propelling the self-propelled adaptor unit, the self-propelled adaptor unit further comprises a first mechanical connection configured to connect to the mechanical connection of the load bearing unit, such that a first mechanical interconnection can be created between the self-propelled adaptor unit and the load bearing unit. The self-propelled adaptor unit further comprises a computer connected to the motor. The computer comprises a receiver for receiving instructions from the self-propelled autonomous or remote-controlled guide unit for controlling the motor. The self-propelled adaptor unit is configured to at least one of: push or pull the load bearing unit in a substantially horizontal direction, and lift the load bearing unit up or down. The self-propelled autonomous or remote-controlled guide unit comprises: a motor, and at least one drive wheel connected to the motor for propelling the self-propelled autonomous or remote-controlled guide unit. The self-propelled autonomous or remote-controlled guide unit further comprises a computer comprising: a transmitter for communicating with the receiver of the self-propelled adaptor unit, a navigation system for navigating in an environment, and at least one sensor for sensing objects in the environment. The self-propelled autonomous or remote-controlled guide unit has less load bearing/pulling capabilities than the self-propelled adaptor unit and the motor(s) of the self-propelled adaptor unit is configured to generate more torque than the motor(s) of the self-propelled autonomous or remote-controlled guide unit. The computer of the self-propelled autonomous or remote-controlled guide unit is configured to generate control signals on the basis of input from the navigation system and the at least one sensor and transmit the control signals using the transmitter to the self-propelled adaptor unit for controlling the motor of the self-propelled adaptor unit.

The present invention provides a flexible autonomous or remote-controlled system which can handle the challenges with varying payloads in an intralogistics environment, while increasing the safety for human operators in the environment and reducing the unit cost.

According to one embodiment, the self-propelled autonomous or remote-controlled guide unit and the self-propelled adaptor unit are propelled only by the motor of the self-propelled adaptor unit, when the self-propelled autonomous or remote-controlled guide unit and the self-propelled adaptor unit are connected.

According to one embodiment, the computer of the self-propelled autonomous or remote-controlled guide unit comprises a faster processing unit than the computer of the self-propelled adaptor unit, such that the computer on the self-propelled adaptor unit can be made simpler.

The self-propelled autonomous or remote-controlled guide unit may have a top speed which is at least 200% of the top speed of the self-propelled adaptor unit.

According to one embodiment, the self-propelled autonomous or remote-controlled guide unit substantially lacks load bearing capabilities.

According to one embodiment, the self-propelled autonomous or remote-controlled guide unit has a weight in the range 10-200 kg, and the self-propelled autonomous or remote-controlled guide unit may comprise at least one motor and at least one break configured to handle weight in the range 10-200 kg.

According to one embodiment, the self-propelled adaptor unit is configured to carry or pull a load exceeding 1000 kg, and the self-propelled adaptor unit may comprise at least one motor and at least one break configured to handle weight exceeding 1000 kg. According to one embodiment, the computer of the self-propelled adaptor unit comprises a transceiver, and the receiver is part of the transceiver, and the computer of the self-propelled autonomous or remote-controlled guide unit comprises a transceiver, and the transmitter is part of the transceiver. The transceivers enable the computer of the self-propelled adaptor unit and the computer of the self-propelled autonomous or remote-controlled guide unit to communicate with each other by two-way communication.

According to one embodiment, the self-propelled adaptor unit comprises a second mechanical connection, and the self-propelled autonomous or remote-controlled guide unit comprises a mechanical connection configured to connect to the second mechanical connection of the self-propelled adaptor unit, such that a second mechanical interconnection can be created between the self-propelled adaptor unit and the self-propelled autonomous or remote-controlled guide unit.

According to one embodiment, the self-propelled autonomous or remote-controlled guide unit and the self-propelled adaptor unit each comprises an electrical connection, such that the self-propelled autonomous or remote-controlled guide unit can be electrically connected to the self-propelled adaptor unit.

According to one embodiment, the electrical connection of the self-propelled autonomous or remote-controlled guide unit and the self-propelled adaptor unit, is configured to transfer electrical energy for powering the motor of the self-propelled adaptor unit.

According to one embodiment, the self-propelled autonomous or remote-controlled guide unit comprises an energy storage for powering the self-propelled adaptor unit.

According to one embodiment, the self-propelled autonomous or remote-controlled guide unit comprises an energy source for powering the self-propelled adaptor unit.

According to one embodiment, the electrical connection of the self-propelled autonomous or remote-controlled guide unit and the self-propelled adaptor unit is configured to transfer data.

According to one embodiment, the transceivers of the self-propelled autonomous or remote-controlled guide unit and the self-propelled adaptor unit are wireless transceivers, enabling the self-propelled autonomous or remote-controlled guide unit and the self-propelled adaptor unit to communicate with each other also when they are not connected (e.g. before or after connection).

According to one embodiment, the first mechanical connection of the self-propelled adaptor unit comprises at least one of a recess and a protrusion and the mechanical connection of the load bearing unit comprises at least one of a corresponding recess or protrusion for mechanical interconnection between the self-propelled adaptor unit and the load bearing unit.

According to one embodiment, the second mechanical connection of the self-propelled adaptor unit comprises at least one of a recess and a protrusion and the mechanical connection of the self-propelled autonomous or remote-controlled guide unit comprises at least one of a corresponding recess or protrusion for mechanical interconnection between the self-propelled adaptor unit and the self-propelled autonomous or remote-controlled guide unit.

According to one embodiment, the self-propelled adaptor unit further comprises at least one sensor, and the transceiver of the self-propelled adaptor unit is configured to transmit sensor data to the transceiver of the self-propelled autonomous or remote-controlled guide unit. Sensor data could for example be data pertaining to the load bearing unit, the payload or the current state of the self-propelled adaptor unit. The self-propelled autonomous or remote-controlled guide unit could be configured to generate control signals on the basis of the received sensor data. The sensor could be at least one sensor selected from a list consisting of pressure sensors, motion sensors and Lidar.

According to one embodiment, the self-propelled autonomous or remote-controlled guide unit is configured to be placed at least partially under the self-propelled adaptor unit.

According to one embodiment, the at least one support element of the load bearing unit is configured for supporting a Euro-pallet.

According to one embodiment, the first mechanical connection of the self-propelled adaptor unit is configured for supporting a Euro-pallet.

According to one embodiment, the self-propelled adaptor unit further comprises an actuator for lifting the load bearing unit up or down.

According to one embodiment, the actuator comprises a forklift mast assembly and the first mechanical connection of the self-propelled adaptor unit is comprised as part of the forklift mast assembly.

According to one embodiment, the actuator comprises a crane mast assembly and the first mechanical connection of the self-propelled adaptor unit is comprised as part of the crane mast assembly.

According to one embodiment, the first mechanical interconnection is configured to fixate the self-propelled adaptor unit to the load bearing unit both in a direction of a length axis (LA) of the self-propelled adaptor unit and in a direction perpendicular to the length axis (LA) of the self-propelled adaptor unit.

According to one embodiment, the second mechanical interconnection is configured to fixate the self-propelled autonomous or remote-controlled guide unit to the self-propelled adaptor unit both in a direction of a length axis (LA) of the self-propelled adaptor unit and in a direction perpendicular to the length axis (LA) of the self-propelled adaptor unit.

The self-propelled adaptor unit may further comprise an optical sensor configured to sense a mobile optical marker within a sensor area.

The self-propelled adaptor unit may be configured to move a load exceeding at least one of: 100 kg, 1000 kg and 5000 kg.

According to one embodiment, the self-propelled autonomous or remote-controlled guide unit is placed and control the self-propelled adaptor unit at a distance from the load bearing unit, such that the self-propelled adaptor unit is located between the self-propelled autonomous or remote-controlled guide unit and the load bearing unit.

According to one embodiment, the self-propelled autonomous or remote-controlled guide unit comprises at least double the computing power of the self-propelled adaptor unit, wherein computing power is defined by one of RAM, instructions per second, clock speed (Ghz), and bits.

According to one embodiment, the motor of the self-propelled adaptor unit comprises at least double the motor power compared to the motor of the self-propelled autonomous or remote-controlled guide unit.

According to one embodiment, the system may comprise at least two self-propelled adaptor units, wherein the at least two self-propelled adaptor units comprise a first self-propelled adaptor unit configured to fulfil a first purpose and a second self-propelled adaptor unit configured to fulfil a second purpose, wherein the first purpose and the second purpose is different.

The first purpose may be connecting to and lifting a load bearing unit, and the second purpose may be to connect to and move a wheeled cart.

According to one embodiment, the system may comprise at least two self-propelled adaptor units, wherein the at least two self-propelled adaptor units comprise a first self-propelled adaptor unit configured to connect to the mechanical connection of a first type of load bearing unit, and a second self-propelled adaptor unit configured to connect to the mechanical connection of a second type of load bearing unit.

The first type of load bearing unit and/or the second type of load bearing unit may be a may be a pallet, Euro-pallet, wheeled cart, roller cage or the like.

According to one embodiment, the self-propelled adaptor unit comprises a main body, and the motor is comprised within the main body.

According to one embodiment, the first mechanical connection is arranged on a first side of the main body and at least one of protruding outwards in a direction transversal to the first side of the main body, and recessing inwards in a direction transversal to the first side of the main body.

According to one embodiment, the first side of the main body has an angle of between 5 to 90 degrees measured from a completely horizontal plane.

According to one embodiment, the first mechanical connection of the self-propelled adaptor unit is connected to an actuator and is configured to engage with and lift a roller cage.

According to one embodiment, the first mechanical connection comprises at least one horizontally protruding element configured to engage with the underside of a roller cage in order to lift the roller cage.

According to one embodiment, the first mechanical connection comprises at least two claws configured to engage with a side of a roller cage in order to clamp the side and lift the roller cage.

According to one embodiment, the first mechanical connection comprises at least one horizontally protruding element configured to engage with the underside of a roller cage and at least one claw configured engage with a side of a roller cage, wherein the at least one horizontally protruding element and at least one claw are configured to clamp the roller cage, such that it can be lifted and/or moved.

A self-propelled adaptor unit for use in the intralogistics system according to any of the embodiments herein is further provided. The self-propelled adaptor unit comprising a motor and at least one drive wheel connected to the motor for propelling both the self-propelled adaptor unit and a self-propelled autonomous or remote-controlled guide unit.

The self-propelled adaptor unit further comprises a first mechanical connection configured to connect to a mechanical connection of a load bearing unit, such that a first mechanical interconnection can be created between the self-propelled adaptor unit and the load bearing unit, and a second mechanical connection configured to connect to the self-propelled autonomous or remote-controlled guide unit, such that a second mechanical interconnection can be created between the self-propelled adaptor unit and the self-propelled autonomous or remote-controlled guide unit. The self-propelled adaptor unit further comprises a sensor configured to generate sensor data related to movement of the at least one drive wheel of the self-propelled adaptor unit and a computer connected to the motor. The computer comprises a transceiver for transmitting the sensor data related to movement of the at least one drive wheel of the self-propelled adaptor unit to the self-propelled autonomous or remote-controlled guide unit and receiving instructions from the self-propelled autonomous or remote-controlled guide unit for controlling the motor. The self-propelled adaptor unit is configured to at least one of: push or pull the load bearing unit in a substantially horizontal direction, and lift the load bearing unit up or down.

According to one embodiment, the computer comprises a transceiver, and the receiver forms part of the transceiver, and the computer is configured to communicate with a computer of the self-propelled autonomous or remote-controlled guide unit.

According to one embodiment, the self-propelled adaptor unit further comprises a second mechanical connection configured to connect to a mechanical connection of the self-propelled autonomous or remote-controlled guide unit, such that a second mechanical interconnection can be created between the self-propelled adaptor unit and the self-propelled autonomous or remote-controlled guide unit.

The self-propelled adaptor unit may further comprise an electrical connection, such that the self-propelled adaptor unit can be electrically connected to the self-propelled autonomous or remote-controlled guide unit. The electrical connection is configured to transfer electrical energy between the self-propelled autonomous or remote-controlled guide unit and the self-propelled adaptor unit for powering the motor of the self-propelled adaptor unit. As such, the self-propelled adaptor unit does not need to have its own power supply, which reduces the risk that the self-propelled adaptor unit does not function when needed as a result of depleted batteries.

The transceiver may be a wireless transceiver enabling communication between the self-propelled adaptor unit and the self-propelled autonomous or remote-controlled guide unit without the self-propelled adaptor unit and the self-propelled autonomous or remote-controlled guide unit being physically connected.

According to one embodiment, the first mechanical connection comprises at least one of a recess and a protrusion corresponding to at least one of a recess and a protrusion of the load bearing unit for mechanical interconnection between the self-propelled adaptor unit and the load bearing unit.

According to one embodiment, the second mechanical connection comprises at least one of a recess and a protrusion corresponding to at least one of a recess and a protrusion of the self-propelled autonomous or remote-controlled guide unit for mechanical interconnection between the self-propelled adaptor unit and the self-propelled autonomous or remote-controlled guide unit.

The self-propelled adaptor unit may further comprise at least one sensor, and the transceiver may be configured to transmit sensor data to the transceiver of the self-propelled autonomous or remote-controlled guide unit. The at least one sensor may be selected from a list of sensors consisting of pressure sensors, motion sensors and Lidar.

The self-propelled adaptor unit may further comprise an actuator for lifting the load bearing unit up or down. According to one embodiment, the actuator comprises a forklift mast assembly and the at least one support element is comprised as part of the forklift mast assembly, and according to another embodiment, the actuator comprises a crane mast assembly and the at least one support element of the self-propelled adaptor unit is comprised as part of the crane mast assembly.

The first mechanical interconnection may be configured to fixate the self-propelled adaptor unit to the load bearing unit both in a direction of a length axis (LA) of the self-propelled adaptor unit and in a direction perpendicular to the length axis (LA) of the self-propelled adaptor unit.

The second mechanical interconnection may be configured to fixate the self-propelled autonomous or remote-controlled guide unit to the self-propelled adaptor unit both in a direction of a length axis (LA) of the self-propelled adaptor unit and in a direction perpendicular to the length axis (LA) of the self-propelled adaptor unit.

According to one embodiment, the self-propelled adaptor unit comprises an optical sensor configured to sense a mobile optical marker within a sensor area.

According to one embodiment, the self-propelled adaptor unit is configured to move a load exceeding one of 100 kg, 1000 kg and 5000 kg.

According to a second aspect there is provided, a connection system for connecting a self-propelled autonomous or remote-controlled guide unit to a self-propelled adaptor unit, the self-propelled autonomous or remote-controlled guide unit being configured to guide the self-propelled adaptor unit for moving on the floor surface when the self-propelled autonomous or remote-controlled guide unit and the self-propelled adaptor unit are connected, the connection system comprising:
a first recess or protrusion on the self-propelled autonomous or remote-controlled guide unit comprising a load bearing portion
a second recess or protrusion on the self-propelled adaptor unit,
a first electrical connector on the self-propelled autonomous or remote-controlled guide unit, and
a second electrical connector on the self-propelled adaptor unit, wherein
the first recess or protrusion is configured to engage the second recess or protrusion for mechanically connecting the self-propelled autonomous or remote-controlled guide unit to the self-propelled adaptor unit and the first and second electrical connectors are configured to be connected for electrically connecting the self-propelled autonomous or remote-controlled guide unit to the self-propelled adaptor unit, wherein the connection system further comprises:
an actuator configured to move at least one of the first recess or protrusion and the second recess or protrusion for engaging the first recess or protrusion to the second recess or protrusion, and wherein at least one of the first and second electrical connectors are configured to be actuated for connecting the first electrical connector to the second electrical connector, and
a control unit for controlling the actuation of:
   at least one of the first recess or protrusion and the second recess or protrusion, and
   at least one of the first and second electrical connector, wherein
the control unit is configured to control the actuation such that the first recess or protrusion engages the second recess or protrusion before the first electrical connector engages the second electrical connector, such that the actuation of at least one of the first recess or protrusion and the second recess or protrusion aligns the first electrical and the second electrical connector before the first electrical connector engages the second electrical connector.

According to one embodiment, the actuation of one of at least the first and second electrical connectors are actuated by the actuator comprised by the connection system.

According to one embodiment, the actuation of one of at least the first and second electrical connectors are actuated by a second actuator comprised by the connection system.

According to one embodiment, the first recess or protrusion on the self-propelled autonomous or remote-controlled guide unit comprises a protrusion.

According to one embodiment, the second recess or protrusion on the self-propelled adaptor unit comprises a recess.

According to one embodiment, the first recess or protrusion on the self-propelled autonomous or remote-controlled guide unit comprises a set of protrusions and one recess.

According to one embodiment, the second recess or protrusion on the self-propelled adaptor unit comprises a set of recesses and one protrusion.

According to one embodiment, the first recess or protrusion is configured to engage the second recess or protrusion in a two step process, by first abutting the first and second recess or protrusions in a horizontal direction and subsequently moving the first recess or protrusion in a vertical direction to engage the second recess or protrusion.

According to one embodiment, the vertical direction is a movement of the first recess or protrusion in a direction towards the floor surface.

The self-propelled adaptor unit according to any of the embodiments may further comprise an inductive charger for inductively charging an energy source of the self-propelled autonomous or remote-controlled guide unit, when the adaptor unit and guide unit is engaged in an electrical connection.

The self-propelled adaptor unit according to any of the embodiments may further be equipped with a ballast load to secure adequate weight of the adaptor unit to securely break or accelerate when moving a heavy load bearing unit. The ballast load may increase the total weight of the adaptor unit such that the total weight of the adaptor unit is 2, 3, 4, 5, 6, 7, 8, 9, 10, 11, 12, 13, 14, 15, 16, 17, 18, 19 or 20 times that of the total weight of the self-propelled autonomous or remote-controlled guide unit.

Please note that any aspect or part of an aspect as well as any method or part of method or any unit, feature or system could be combined in any applicable way if not clearly contradictory.

### BRIEF DESCRIPTIONS OF THE DRAWINGS

The invention will by way of example be described in more detail with reference to the appended schematic drawings, on which:

FIG. 1A shows a self-propelled adaptor unit for an intralogistics system in an elevated perspective view.

FIG. 1B shows a self-propelled adaptor unit for an intralogistics system in a top view.

FIG. 1C shows the self-propelled adaptor unit of FIG. 1A illustrated with a cut out section to show internal parts of the adaptor unit.

FIG. 1D shows a self-propelled adaptor unit for an intralogistics system in an elevated perspective view. FIG. 2A shows a self-propelled autonomous or remote-controlled guide unit, a self-propelled adaptor unit, and a load bearing unit for an intralogistics system in an elevated perspective view, according to a first embodiment.

FIG. 2B shows a mechanical connection of a self-propelled autonomous or remote-controlled guide unit and a corresponding mechanical connection of a self-propelled adaptor unit in an elevated side view.

FIG. 3 shows a self-propelled autonomous or remote-controlled guide unit, a self-propelled adaptor unit, and a load bearing unit for an intralogistics system in an elevated perspective view, according to a second embodiment.

FIG. 4 shows a self-propelled autonomous or remote-controlled guide unit, a self-propelled adaptor unit, and a load bearing unit for an intralogistics system in an elevated perspective view, according to a third embodiment.

FIG. 5 shows a self-propelled autonomous or remote-controlled guide unit, a self-propelled adaptor unit, and a load bearing unit for an intralogistics system in an elevated perspective view, according to a fourth embodiment.

FIG. 6 shows a self-propelled autonomous or remote-controlled guide unit, a self-propelled adaptor unit, and a load bearing unit for an intralogistics system in an elevated perspective view, according to a fifth embodiment.

FIG. 7 shows a self-propelled autonomous or remote-controlled guide unit, a self-propelled adaptor unit, and a load bearing unit for an intralogistics system in an elevated perspective view, according to a sixth embodiment.

FIG. 8a shows a self-propelled autonomous or remote-controlled guide unit for an intralogistics system in a frontal elevated perspective view.

FIG. 8b shows the self-propelled autonomous or remote-controlled guide unit of FIG. 8a illustrated with a cut out section to show internal parts.

FIG. 8c shows the self-propelled autonomous or remote-controlled guide unit of FIGS. 8a and 8b in an elevated perspective view from behind and illustrated with cut out sections to show internal parts.

FIG. 9 shows the self-propelled adaptor unit of FIG. 3 illustrated with a cut out section to show internal parts.

FIG. 10 shows a self-propelled adaptor unit for an intralogistics system in an elevated perspective view.

FIG. 11 shows a self-propelled adaptor unit for an intralogistics system in an elevated perspective view.

FIG. 12 shows a self-propelled autonomous or remote-controlled guide unit for an intralogistics system in an elevated perspective view, wherein the guide unit comprises an alternative mechanical connection.

FIG. 13 shows a self-propelled adaptor unit for an intralogistics system in an elevated perspective view, wherein the adaptor unit comprises a corresponding mechanical connection to that of the guide unit of FIG. 12.

FIG. 14 shows a self-propelled adaptor unit for an intralogistics system in an elevated perspective view, wherein the adaptor unit comprises a corresponding mechanical connection to that of the guide unit of FIG. 12.

FIG. 15a-15c show an alternative design of a self-propelled adaptor unit for an intralogistics system in perspective views, wherein the adaptor unit comprises a corresponding mechanical connection to that of the guide unit of FIG. 12 and means for inductive charging of the adaptor unit.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided for thoroughness and completeness.

Variations to the disclosed embodiments can be understood and effected by the skilled person in practicing the claimed invention, from a study of the drawings, the disclosure, and the appended claims.

In many intralogistics environments, the payload sizes and travel distances vary greatly. In a typical warehouse environment, the intralogistics is made up of one section for receiving incoming goods for storage in the warehouse. The incoming goods typically arrive in large quantities in the form of truck loads or containers from suppliers from all over the world. Depending on the size of the goods and the package standards of the country of origin, goods can arrive in many forms. As an example, goods may arrive on pallets. Pallets typically range in sizes from of about 400 mm*300 mm to 2400 mm*800 mm which means that the means for handling the pallets also must be able to vary. It may be so that the goods should be stored on the pallet, moved from the pallet to a wheeled cart or moved from the pallet to a dedicated shelf. It may also be so that the entire pallet should be moved onto a cart for further transportation and/or storage in the warehouse. Goods may also arrive simply in stacked boxes, e.g. in a container. In such cases, the boxes should maybe be placed onto pallets, or be placed on a cart for further transportation and/or storage in the warehouse. Also, when it comes to wheeled carts, the sizes and possible payloads vary greatly with the size of the goods and the layout of the warehouse.

A typical warehouse further comprises a section for outgoing goods. Typically, outgoing goods is more mixed both in size and contents. In one example, the warehouse is a fulfilment warehouse for consumer goods. A fulfilled order, and thereby the outgoing goods, comprises boxes of varying sizes, with varying contents for shipment to different locations. To handle the final part of the logistics, carts of varying sizes and/or outfitted with various accessories for handling boxes of different sizes may be used. These carts may be pulled as a train or pushed or pulled individually.

As can be understood from the above description of a warehouse environment, the number of variations can be very large and require a very flexible system for intralogistics. The same goes for the intralogistics of a production facility.

In most intralogistics environments, the use of AGVs (Automated Guided Vehicles) or AMRs (Autonomous Mobile Robots) is increasing. The use of AGV's and AMR's reduces the number of staff in the intralogistics environment as well as enables increased speed and precision. AGV's and AMR's are expensive and sophisticated equipment having a multitude of sensors and high computing capabilities such that they can safely navigate in an intralogistics environment which may have a mix of human operators and autonomous vehicles. Increasing the load bearing capabilities of the AGV's or AMR's, such that they can handles all types of loads that may arise in an intralogistics environment in an efficient way makes the units even more expensive. Also, increasing the strength and battery capacity of the AGV's or AMR's also makes them heavier, making them even more dangerous to human operators in the intralogistics environments, also when they are moving without carrying any load.

The present invention provides a flexible autonomous or remote-controlled system which can handle the challenges with varying payloads in an intralogistics environment, while increasing the safety for human operators in the environment and reducing the unit cost. The invention is based on the concept that a highly sophisticated and capable self-propelled autonomous or remote-controlled unit is primarily used as a guid unit. The self-propelled autonomous or remote-controlled guid unit then connects to a self-propelled adaptor unit which provides both the force and propulsion for handling the payload, as well as the interface suitable for handling the particular payload. This creates a system in which a small number of highly sophisticated guide units can connect to range of less sophisticated self-propelled adapter units, which in turn can connect to an even wider range of even less sophisticated payloads (such as wheeled carts or pallets).

Hence, a logistic system using guiding units for controlling self-propelled adaptor units to move load bearing units is provided, as well as self-propelled adaptor units for moving load bearing units in such a system. The logistics system may be used in an intralogistics system in which material, goods or items need to be transported in an efficient and/or autonomous way.

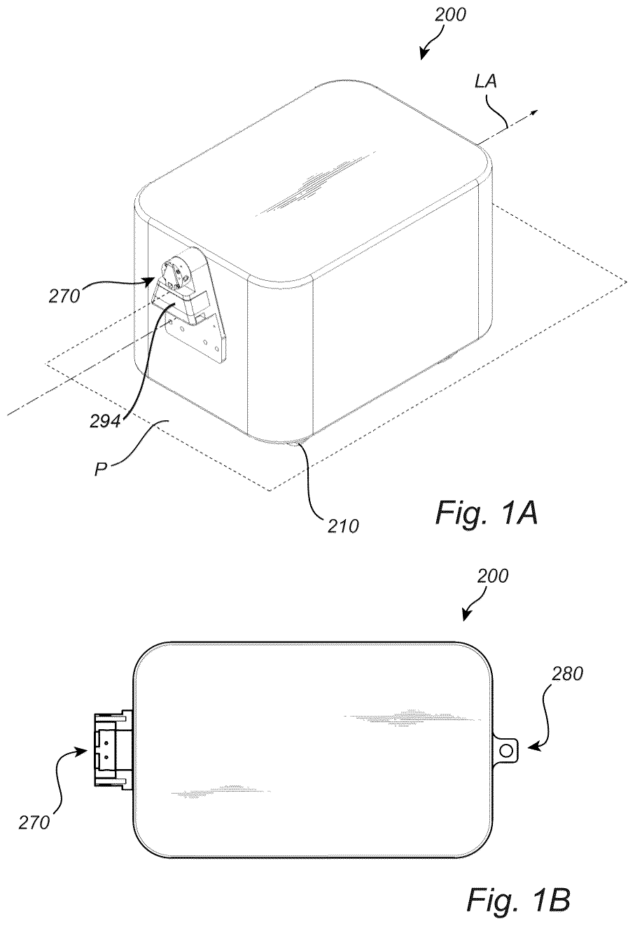

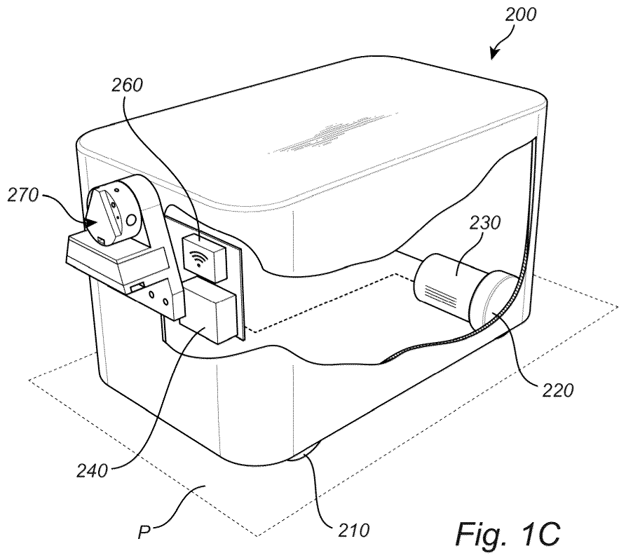

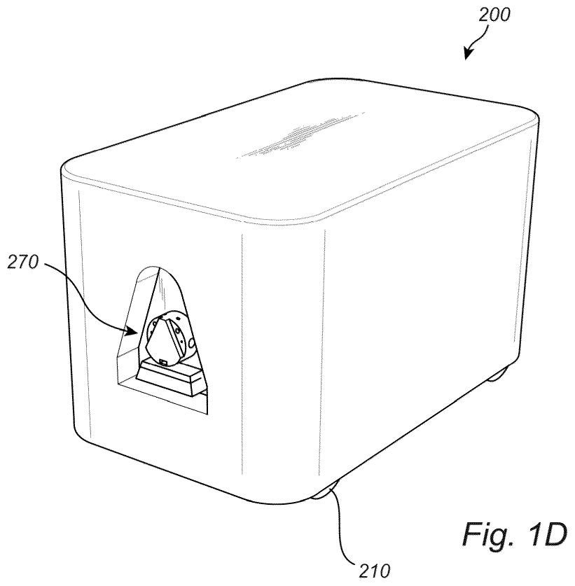

FIG. 1A to 1C shows a self-propelled adaptor unit 200 for use in an intralogistics system according to a first embodiment of the invention, the self-propelled adaptor unit 200 comprises a motor 230, shown in FIG. 1C, and two drive wheels 220, shown in FIG. 1C located centrally in relation to a length axis (LA) of the self-propelled adaptor unit 200. The drive wheels are connected to the motor for propelling the self-propelled adaptor unit 200. The drive wheels are surrounded by four swivelling castors 210, each located in a corner of the self-propelled adaptor unit 200. The drive wheels enable movement control in all directions on a planar surface by altering the rotational speed and/or direction of the drive wheels. The drive wheels are drive wheels suitable for use in a warehouse or factory setting and may be drive wheels suitable for use on a flat concrete floor. The drive wheels are connected to rotary encoders, sensing the rotational speed of a particular drive wheel. The information derived by the rotary encoder may be used to compare the rotational speed of a particular drive wheel to the speed of other drive wheel or the speed of the self-propelled adaptor unit 200. The information of the movement of the drive wheels may be used as navigation information, it is important that traction is maintained between the floor surface P and the drive wheels.

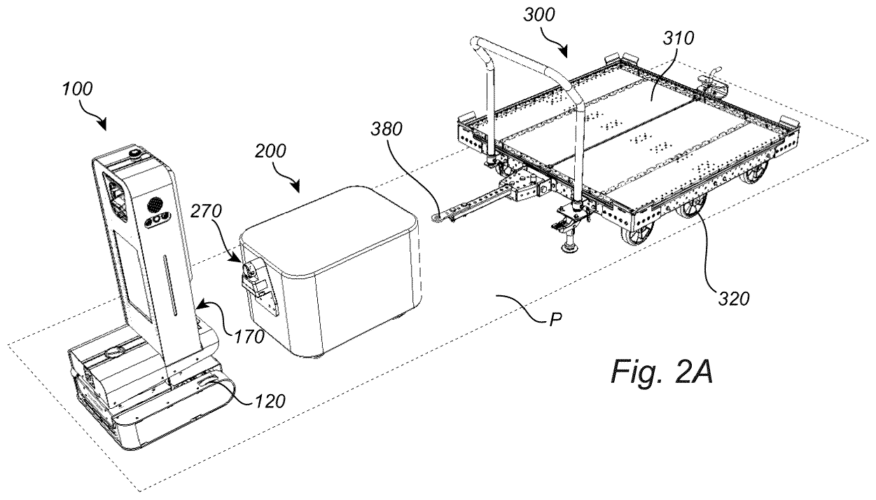

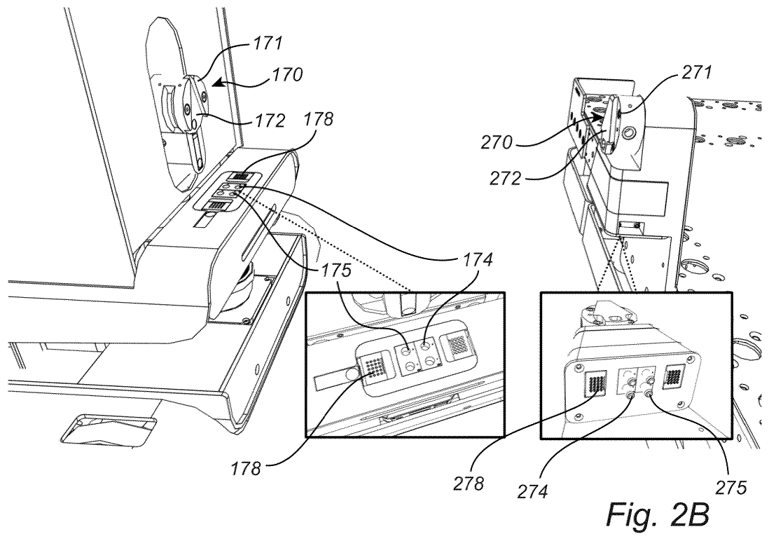

The self-propelled adaptor unit 200 comprises a first mechanical connection 280, shown in FIG. 1B, configured to connect to a mechanical connection of a load bearing unit 300, such as the one shown in FIG. 2A, thereby a first mechanical interconnection can be created between the self-propelled adaptor unit 200 and a load bearing unit 300.

The first mechanical interconnection may be configured to fixate the self-propelled adaptor 200 to a load bearing unit 300 both in a direction of the length axis (LA) of the self-propelled adaptor unit 200 and in a direction perpendicular to the length axis (LA) of the self-propelled adaptor unit 200.

The self-propelled adaptor unit 200 further comprises a second mechanical connection 270 configured to connect to a mechanical connection of a self-propelled autonomous or remote-controlled guide unit 100, such as the one shown in FIG. 2A, thereby a second mechanical interconnection can be created between the self-propelled adaptor unit 200 and a self-propelled autonomous or remote-controlled guide unit 100.

The second mechanical interconnection may be configured to fixate the self-propelled adaptor unit 200 to the self-propelled autonomous or remote-controlled guide unit 100 both in a direction of a length axis (LA) of the self-propelled adaptor unit 200 and in a direction perpendicular to the length axis (LA) of the self-propelled adaptor unit 200.

The self-propelled adaptor unit 200 comprises a computer 240, shown in FIG. 1C) configured to control the motor and thus the movement of the drive wheels, as well as handle inputs and communication.

The computer preferably comprises a transceiver 260 configured to communicate with a computer 191 of the self-propelled autonomous or remote-controlled guide unit 100, for controlling the motor and thus the rotational speed and/or direction of the drive wheels. Preferably the comprised transceiver which is configured to transmit and receive wireless communication to and/or from the self-propelled autonomous or remote-controlled guide unit 100 and/or a mobile unit operated by a driver and/or a stationary wireless unit being part of a logistic system. The wireless communication could be information or data e.g. relating to driving or navigation of the self-propelled adaptor unit 200, or identity information or information with regards to the load on the load bearing unit 300 (weight, height etc.).

Alternatively, the computer 240 may comprise a receiver for receiving instructions from a self-propelled autonomous or remote-controlled guide unit 100 for controlling the motor and thus the rotational speed and/or direction of the drive wheels.

The self-propelled adaptor unit 200 may further comprise sensors 294 e.g. optical or contact sensors. One function of such sensor may be for creating an emergency stop signal in case the self-propelled adaptor unit 200 inadvertently makes contact with an object or person. The computer will handle all inputs from sensors of the self-propelled adaptor unit 200. An emergency stop signal may be transferred to a self-propelled autonomous or remote-controlled guide unit 100 such that the self-propelled autonomous or remote-controlled guide unit 100 can control the propulsion of the self-propelled adaptor unit 200.

FIG. 1D shows an alternative embodiment of a self-propelled adaptor unit 200, the self-propelled adaptor unit 200 is similar to the of the embodiments of FIG. 1A to FIG. 1C except the second mechanical connection 270 is recessed from the surface which is faced toward a self-propelled autonomous or remote-controlled guide unit 100 when mechanical interconnected thereto.

FIG. 2A shows an embodiment of a system for intralogistics comprising a load bearing unit 300, a self-propelled adaptor unit 200 according to the embodiments shown in FIGS. 1A and 1B, and a self-propelled autonomous or remote-controlled guide unit 100.

The load bearing unit 300 according to the embodiment of FIG. 2A comprises a mechanical connection 380, a supporting element 310 on which a load can be placed, and six wheels 320 enabling the load bearing unit 300 to be rolled on a floor surface P.

The self-propelled adaptor unit 200 is configured to either push or pull the load bearing unit 300, in a substantially horizontal direction and thus must comprise enough motor power to complete the desired task.

The self-propelled autonomous or remote-controlled guide unit 100 is remote controlled and/or autonomous and is more competent than the self-propelled adaptor unit 200 but have less load bearing/pulling capabilities.

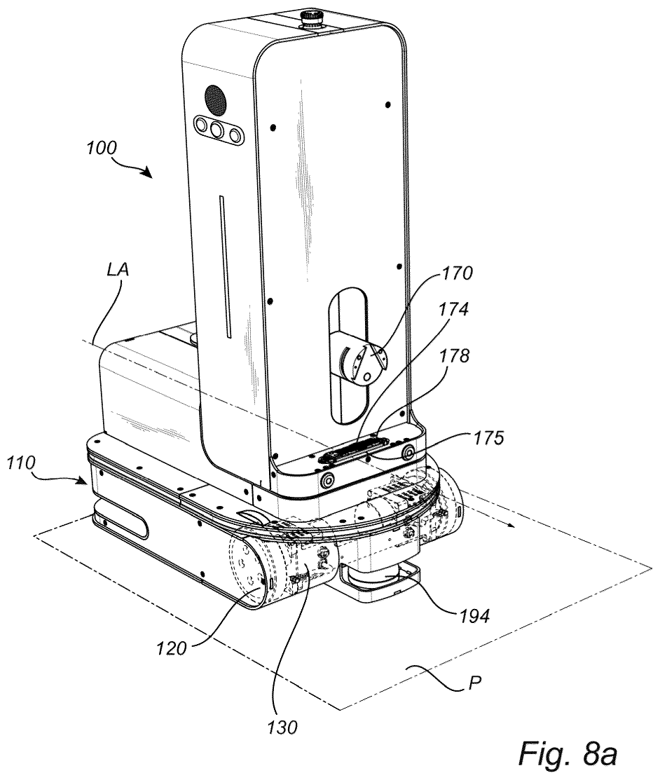

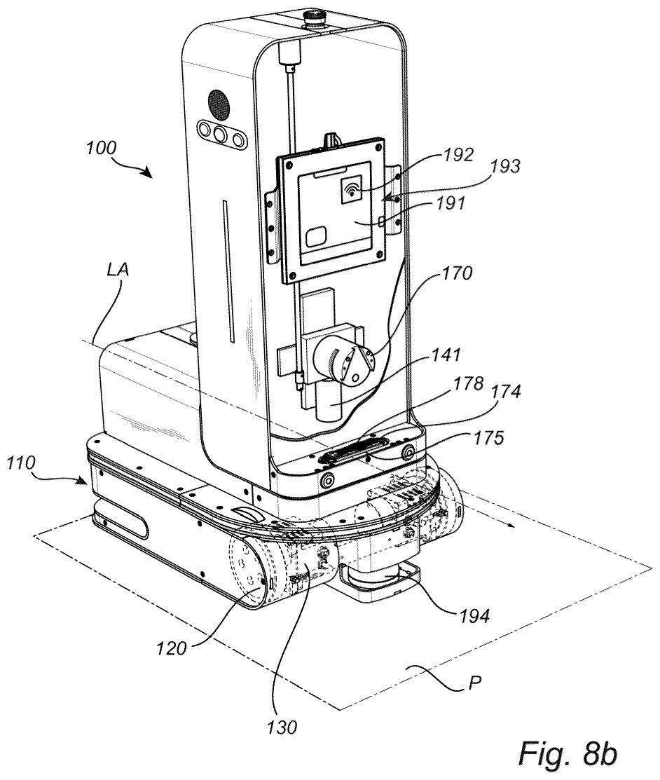

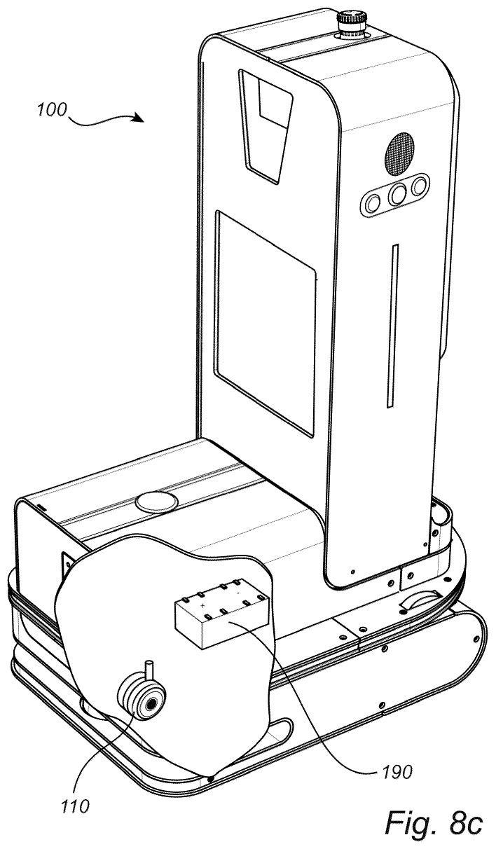

The self-propelled autonomous or remote-controlled guide unit 100 comprises a motor 130 (see FIG. 8A/B) and two drive wheels 120 located at the corners in the front portion of the self-propelled autonomous or remote-controlled guide unit 100 and one swivelling castor 110 (see FIG. 8C) located centrally in the rear portion of the self-propelled autonomous or remote-controlled guide unit 100. The two drive wheels 120 enables control in all directions on a planar surface by altering the rotational speed and/or direction of the drive wheels 120. The drive wheels 120 are drive wheels 120 suitable for use in a warehouse or factory setting and may be drive wheels 120 suitable for use on a flat concrete floor. The drive wheels are connected to rotary encoders, sensing the rotational speed of a particular drive wheel 120. The information derived by the rotary encoder may be used to compare the rotational speed of a particular drive wheel 120 to the speed of other drive wheel or the speed of the self-propelled autonomous or remote-controlled guide unit 100 or the speed of the drive wheels of the self-propelled adaptor unit 200 or the speed of the self-propelled adaptor unit 200. The information of the movement of the drive wheels 120 may be used as navigation information. It is important that traction is maintained between the floor surface P and the drive wheels 120.

The self-propelled autonomous or remote-controlled guide unit 100 further comprises a computer 191 (see FIG. 8B). The computer 191 comprises a transmitter possibly comprised by a transceiver 192 for communicating with the transceiver or receiver of the self-propelled adaptor unit 200, a navigation system 193 for navigating in an environment (see FIG. 8B), and at least one sensor 194 (see FIG. 8A) for sensing objects in the environment. The at least one sensor 194 of the self-propelled autonomous or remote-controlled guide unit 100 may be chosen from a list consisting of pressure sensors, motion sensors and Lidar. Alternative sensors on the self-propelled autonomous or remote-controlled guide unit 100 could also be radar units, sonic sensor units and/or optical sensor units, IR or cameras using image recognition.

The computer of the self-propelled autonomous or remote-controlled guide unit 100 is configured to generate control signals on the basis of input from the navigation system and the at least one sensor and transmit the control signals using the transmitter to the self-propelled adaptor unit 200 for controlling the motor 230 of the self-propelled adaptor unit 200.

The computer of the self-propelled autonomous or remote-controlled guide unit 100 is much more sophisticated than the computer of the self-propelled adaptor unit 200. The more sophisticated computer of the self-propelled autonomous or remote-controlled guide unit 100 has a faster processing unit, a larger storage capacity, faster connection to other self-propelled autonomous or remote-controlled guide units 100 or to the logistics systems or to the self-propelled adaptor units 200. The computer of the self-propelled autonomous or remote-controlled guide unit 100 further comprises more 1/O-units than the computer of the self-propelled adaptor unit 200, enabling the self-propelled autonomous or remote-controlled guide unit 100 to receive input from more sensors.

The self-propelled autonomous or remote-controlled guide unit 100 may further and additionally to the above-mentioned features comprise a wireless communication unit configured to transmit and receive wireless communication to and/or from at least one of: a self-propelled adaptor unit 200, other self-propelled autonomous or remote-controlled guide units 100 or stationary wireless units being part of the logistic system. The wireless communication unit could be based on the IEEE 802.11 standard (WLAN or Wi-Fi) or UHF radio communication such as the IEEE 802.15.1 standard (Bluetooth) or a wireless communication unit based on the 3GPP NR standards (5G) enabling Ultra-Reliable Low-Latency Communications (URLLC). The wireless communication could be information or data e.g. relating to the identity of the self-propelled autonomous or remote-controlled guide units 100, the identity of the self-propelled adaptor units 200 or the identity of the load bearing units 300.

The wireless communication between the self-propelled adaptor unit 200 and the self-propelled autonomous or remote-controlled guide unit 100 may be bidirectional, such that the self-propelled autonomous or remote-controlled guide unit 100 may transmit and/or receive information from/to the self-propelled adaptor unit 200, which information could comprise, apart from identity information, specifics of a load on the load bearing unit (weight, height etc.). It is further possible to transmit and/or receive more complex data such as navigation information such as driving instructions or information about the surroundings to or from the self-propelled autonomous or remote-controlled guide unit 100.

The self-propelled autonomous or remote-controlled guide unit 100 may further comprise an energy source 190 or energy storage 190 for powering the self-propelled adaptor unit 200.

The system for intralogistics shown in FIG. 2A utilizes a work distribution between the different units where the self-propelled autonomous or remote-controlled guide unit 100 has more computing power, enabling better sensing, steering and navigation in an environment and less load bearing/pulling capabilities compared to the self-propelled adaptor unit 200. The self-propelled adaptor unit 200 in turn has more computing power, enabling better sensing, steering and navigation in an environment and more load bearing/pulling capabilities than the load bearing unit 300, which has no competencies except being able to hold a load and being movable.

This makes it possible to exclude sophisticated, sensitive, and expensive components from the self-propelled adaptor unit 200 and to a larger degree the load bearing unit 300, making the self-propelled adaptor unit 200 and load bearing unit 300 easier to manufacture, more robust and reduces the maintenance cost of the self-propelled adaptor unit 200 and load bearing unit 300. As the self-propelled adaptor unit 200 is self-propelled, i.e. not pulled by the self-propelled autonomous or remote-controlled guide unit 100, the self-propelled autonomous or remote-controlled guide unit 100 can be made smaller, lighter and faster, making it possible to have the self-propelled autonomous or remote-controlled guide unit 100 move about for example a factory setting without many of the risks to human operators that unavoidably are present when moving large and heavy loads. It is also possible to have the self-propelled autonomous or remote-controlled guide unit 100 coordinating a larger amount of self-propelled adaptor units 200. It is also possible to have one type of self-propelled autonomous or remote-controlled guide unit 100 and controlling a large variety of self-propelled adaptor units 200.

The load bearing units 300 are not self-propelled and has to be moved by the self-propelled adaptor unit 200, which in turn is controlled by the self-propelled autonomous or remote-controlled guide unit 100. The self-propelled adaptor unit 200 may come in different forms, adapted to different kinds of load bearing units 300. This way it is possible to have a large number of load bearing units 300, which is moved by a lower number of adaptor units 200, which in turn is controlled by a lower number of self-propelled autonomous or remote-controlled guide units 100.

The self-propelled autonomous or remote-controlled guide unit 100 has a top speed which is at least 200% of the top speed of the self-propelled adaptor unit 200, which means that the self-propelled autonomous or remote-controlled guide unit 100 can move around in an environment, such as a factory, much quicker when not being connected to a self-propelled adaptor unit 200.

However, the self-propelled autonomous or remote-controlled guide unit 100 lacks load bearing capabilities and has a weight in the range 10-100 kg or 10-200 kg, which means that that the motors of the self-propelled autonomous or remote-controlled guide unit 100 only need to create a torque sufficient for accelerating the self-propelled autonomous or remote-controlled guide unit 100 with a weight in the range 10-100 kg or 10-200 kg and the breaks only need to be capable of deaccelerating the self-propelled autonomous or remote-controlled guide unit 100 with a weight in the range 10-100 kg or 10-200 kg.

In contrast, the self-propelled adaptor unit 200 described with reference to FIGS. 1A, 1B and 2A are configured to carry a load in the range 100-5000 kg or in the range 300-5000 kg, which means that the motors of the self-propelled adaptor unit 200 need to create a torque sufficient for accelerating the self-propelled adaptor unit 200 with a weight in the range 100-5000 kg or in the range 300-5000 kg and the breaks of the self-propelled adaptor unit 200 need to be capable of deaccelerating the self-propelled adaptor unit 200 with a weight in the range 100-5000 kg or in the range 300-5000 kg.

The propulsion of the self-propelled autonomous or remote-controlled guide unit 100 and self-propelled adaptor unit 200 when interconnected, may use the combined motor power and drive wheels of the self-propelled autonomous or remote-controlled guide unit 100 and self-propelled adaptor unit 200. Or alternatively, the propulsion of the self-propelled autonomous or remote-controlled guide unit 100 and self-propelled adaptor unit 200 when interconnected, may use only the motor power and drive wheels of the self-propelled adaptor unit 200.

The propulsion (motor and/or motor controller) of the self-propelled autonomous or remote-controlled guide unit 100 could be configured to be disabled when the self-propelled autonomous or remote-controlled guide unit 100 is connecter to the self-propelled adaptor unit 200.

The self-propelled or remote-controlled guide unit 100 could in some embodiments comprise an actuator 141 (see FIG. 8B) configured to lift the self-propelled or remote-controlled guide unit 100 from the floor surface P when the self-propelled autonomous or remote-controlled guide unit 100 is connected to the self-propelled adaptor unit 200, such that only the wheels of the self-propelled adaptor unit 200 engages the floor surface for propelling the self-propelled autonomous or remote-controlled guide unit 100 and the self-propelled adaptor unit 200.

In one exemplifying embodiment, the combined motors for the propulsion of the self-propelled adaptor unit 200 is configured for generating a maximum torque being 3 times the maximum torque of the combined motors for the propulsion of the self-propelled autonomous or remote-controlled guide unit 100.

In another exemplifying embodiment, the combined motors for the propulsion of the self-propelled adaptor unit 200 is configured for generating a maximum torque being 6 times the maximum torque of the combined motors for the propulsion of the self-propelled autonomous or remote-controlled guide unit 100.

The self-propelled autonomous or remote-controlled guide unit 100 also reduces the requirements of the level of sophistication of the safety systems of the self-propelled adaptor unit 200, as the self-propelled autonomous or remote-controlled guide unit 100 can guide, navigate, and sense the environment and control the movement of the self-propelled adaptor unit 200.

FIG. 2B shows a close-up of the connections of the self-propelled autonomous or remote-controlled guide unit 100 and the self-propelled adaptor unit 200 from the embodiment highlighted in FIGS. 1A, 1B and 2A.

The self-propelled autonomous or remote-controlled guide unit 100 comprises a mechanical connection 170 configured to be interconnected with the second mechanical connection 270 of the self-propelled adaptor unit 200. The mechanical connection 170 comprises a recess 172 and a protrusion 171. The recess 172 and protrusion 171 are complimentary to a recess 271 and a protrusion 272 of the mechanical connection 270 of the self-propelled adaptor unit 200, thereby enabling a mechanical interconnection between and the self-propelled autonomous or remote-controlled guide unit 100 and the self-propelled adaptor unit 200.

The mechanical connection 170 of the self-propelled autonomous or remote-controlled guide unit 100 may further comprise a locking member for securely locking the mechanical interconnection between and the self-propelled autonomous or remote-controlled guide unit 100 and the self-propelled adaptor unit 200 for ensuring that the mechanical interconnection is secure.

Shown in the embodiment of FIG. 2B is further an electrical connection on the self-propelled autonomous or remote-controlled guide unit 100 comprising two electrical connections 174, 175 for electrically connecting the self-propelled autonomous or remote-controlled guide unit 100 to the self-propelled adaptor unit 200. The first electrical connection 174 is configured for electrically connecting the self-propelled autonomous or remote-controlled guide unit 100 to the motor of the self-propelled adaptor unit 200 such that the self-propelled autonomous or remote-controlled guide unit 100 can control the propulsion of the self-propelled adaptor unit 200.

The second electrical connection 175 is configured for transferring electrical energy for the purpose of charging a battery on the self-propelled adaptor unit 200, from a battery on the self-propelled autonomous or remote-controlled guide unit 100, or for the purpose of charging a battery on the self-propelled autonomous or remote-controlled guide unit 100 from a charger or charging station connected to the electrical grid, or from a battery on the self-propelled adaptor unit 200 or on another self-propelled autonomous or remote-controlled guide unit 100.

The electrical connection of the self-propelled autonomous or remote-controlled guide unit 100 shown in the embodiment of FIG. 2B further comprises a connection for transferring data 178. The transferred data could for example be navigation data to and from the self-propelled autonomous or remote-controlled guide unit 100. Navigation data could e.g. be data from sensors or information about the surroundings received by the self-propelled autonomous or remote-controlled guide unit 100 or information concerning the movement of the drive wheels of the self-propelled adaptor unit 200 obtained from the motors of the self-propelled adaptor unit 200 or from encoders connected to the drive wheels. Navigation information could also be the movement of the drive wheels of the self-propelled autonomous or remote-controlled guide unit 100 obtained from the motors of the self-propelled autonomous or remote-controlled guide unit 100 or from encoders connected to the drive wheels. Navigation information could also be an emergency stop signal generated by an operator pushing an emergency stop button located on the self-propelled adaptor unit 200 or an emergency stop button located on the self-propelled autonomous or remote-controlled guide unit 100. The emergency stop signal is transferred by the connection for transferring data 178, such that the self-propelled autonomous or remote-controlled guide unit 100 can control the propulsion of the self-propelled adaptor unit 200 for stopping the self-propelled adaptor unit 200.

In the embodiment shown in FIG. 2B, the electrical connections 174,175, as well as the connection for transferring data 178, is a separate connection part than the mechanical connection 170. However, in an alternative embodiment it is equally conceivable that the electrical connections 174,175, as well as the connection for transferring data 178, could form part of an integrated connection together with the mechanical connection 170 enabling simultaneous connection of the mechanical connection 170 and the rest of the connections.

The second mechanical connection 270 of the self-propelled adaptor unit 200 comprises a recess 271 and a protrusion 272 corresponding to at the recess 172 and the protrusion 171 of the mechanical connection 170 of the self-propelled autonomous or remote-controlled guide unit 100. The complimentary recesses and protrusions thus facilitate the mechanical interconnection between the self-propelled adaptor unit 200 and the self-propelled autonomous or remote-controlled guide unit 100.

In the embodiment shown in FIG. 2B, the self-propelled adaptor unit 200 further comprises an electrical connection, comprising two electrical connections 274, 275 which correspond to the two electrical connection 174, 175 of the self-propelled autonomous or remote-controlled guide unit 100, such that the self-propelled adaptor unit 200 can be electrically connected to the self-propelled autonomous or remote-controlled guide unit 100.

The self-propelled adaptor unit 200 further and additionally comprises a connection for transferring data 278 corresponding to the connection for transferring data 178 of the self-propelled autonomous or remote-controlled guide unit 100, such to allow transfer of data between the self-propelled adaptor unit 200 and the self-propelled autonomous or remote-controlled guide unit 100.

In the embodiment shown in FIG. 2B, the electrical connections 274, 275, as well as the connection for transferring data 278, is separate connections from the mechanical connection 270. However, in an alternative embodiment it is equally conceivable that the electrical connections 274, 275, as well as the connection for transferring data 278, could form part of an integrated connection together with the mechanical connection 270 enabling simultaneous connection of the mechanical connection 270 and the rest of the connections.

In the embodiment shown in FIG. 2A/B, the mechanical interconnection involving connecting the mechanical connection 170, electrical connections 174, 175 and connection for transferring data 178 of the self-propelled autonomous or remote-controlled guide unit 100 to the mechanical connection 270, electrical connections 274, 275 and connection for transferring data 278 of the self-propelled adaptor unit, is part of a two-step interconnection process.

The mechanical connections of the self-propelled autonomous or remote-controlled guide unit 100 and self-propelled adaptor unit 200 are arranged to be in close proximity by moving the self-propelled autonomous or remote-controlled guide unit 100 close to the self-propelled adaptor unit 200 in a direction along the length axis (LA) of the self-propelled adaptor unit 200. The mechanical connection 170 of the self-propelled autonomous or remote-controlled guide unit 100 is then in a first step connected to the mechanical connection 270 of the self-propelled adaptor unit 200 by lowering the mechanical connection 170 down over the mechanical connection 270 so that the protruding part 171 of the mechanical connection 170 of the self-propelled autonomous or remote-controlled guide unit 100 encloses the protruding part 272 of the mechanical connection 270 of the self-propelled adaptor unit 200. Thereby the mechanical connections are locked together so the recessed part 172 of the mechanical connection 170 of the self-propelled autonomous or remote-controlled guide unit 100 are in contact with the protruding part 272 of the mechanical connection 270 of the self-propelled adaptor unit 200 and the recessed part 271 of the mechanical connection 270 of the self-propelled adaptor unit 200 is in contact with the protruding part 171 of the mechanical connection 170 of the self-propelled autonomous or remote-controlled guide unit 100. In the second step, of the two-step interconnecting process, the electrical and data transferring connections 174, 175, 178 of the self-propelled autonomous or remote-controlled guide unit 100 is lifted upwards so as to connect to the electrical and data transferring connections 274, 275, 278 of the self-propelled adaptor unit 200. Thereby the interconnection between the self-propelled adaptor unit 200 and the self-propelled autonomous or remote-controlled guide unit 100 enables the connection of the mechanical connections 170, 270 and the rest of the connections 174, 175, 178, 274, 275, 278.

The self-propelled autonomous or remote-controlled guide unit 100 may comprise two linear electrical actuators for enabling the process of the interconnection.

In alternative embodiments, it is equally conceivable that all the connections of the self-propelled autonomous or remote-controlled guide unit 100 and self-propelled adaptor unit 200 are integrated as one single connection including both the mechanical, electrical and data transferring connections, thus enabling a one-step interconnecting process, rather than the aforementioned two-step interconnecting process.

The self-propelled adaptor unit 200 may be powered by the energy source 190 of the self-propelled autonomous or remote-controlled guide unit 100. However, in alternative embodiments the self-propelled adaptor unit 200 may have an energy source of its own which is used on its own or in combination with the energy source of the self-propelled autonomous or remote-controlled guide unit 100. The energy source of the self-propelled adaptor unit 200 may be a smaller battery capable of powering the self-propelled adaptor unit 200 for short movements (such as short directly controlled movements by an operator). The energy source of the self-propelled adaptor unit 200 may be configured to be charged by and from the self-propelled autonomous or remote-controlled guide unit 100 by means of the electrical connections 174, 175, 274, 275.

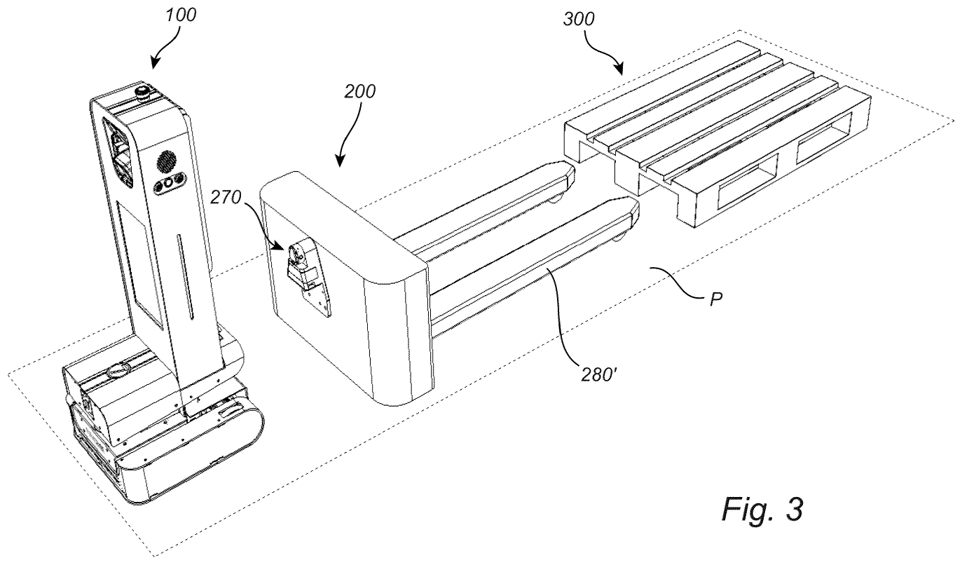

FIG. 3. shows an alternative embodiment of a system for intralogistics comprising a self-propelled autonomous or remote-controlled guide unit 100 according to the aforementioned embodiments, as well as a load bearing unit 300 and a self-propelled adaptor unit 200, wherein the load bearing unit 300 is a Euro-pallet and the self-propelled adaptor unit 200 is configured for supporting, moving and/or to lifting a Euro-pallet.

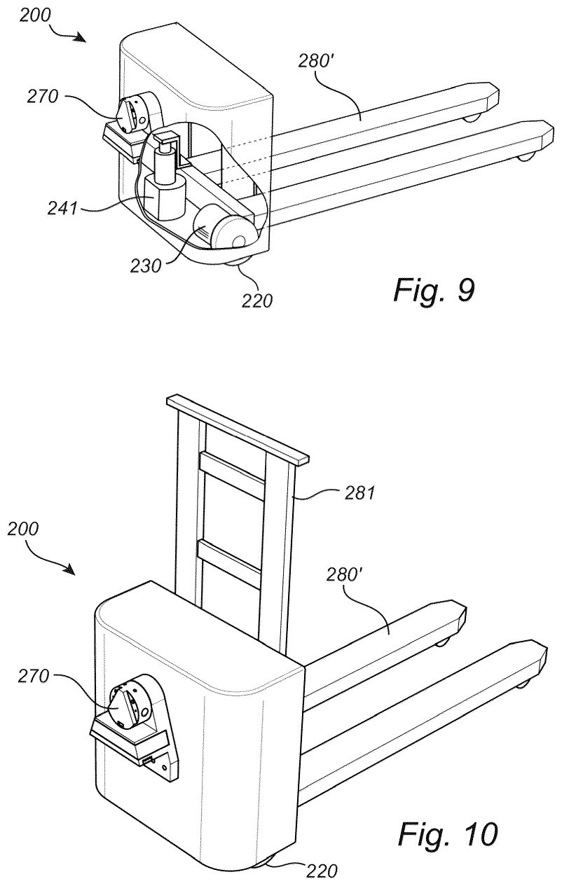

The self-propelled adaptor unit 200 comprises an actuator 241 (see FIG. 9) for controlling a forklift mast assembly 281 (see FIG. 9 and FIG. 10) for lifting the load bearing unit 300 up or down. The forklift mast assembly comprises a fork, which in this particular embodiment constitutes the first mechanical connection 280′ of the self-propelled adaptor unit 200.

The self-propelled adaptor unit 200 further comprises a second mechanical connection 270, a motor, two drive wheels and a computer according to the aforementioned embodiments of FIGS. 1A/1B and 2A/2B.

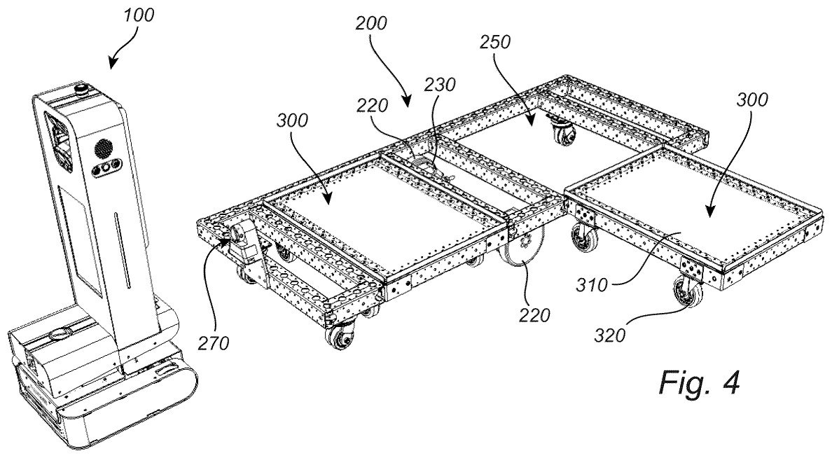

FIG. 4. shows an alternative embodiment of a system for intralogistics comprising a self-propelled autonomous or remote-controlled guide unit 100 according to the aforementioned embodiments, two load bearing units 300 and a self-propelled adaptor unit 200.

The load bearing units 100 each comprises four swivelling castors wheels 320, enabling the load bearing unit to be moved on a floor surface, and a supporting element 310 on which a load can be placed. The load bearing units 300 in this embodiment is designed to be daughter units which fit into an opening 250 in the frame of the self-propelled adaptor unit 200 which in this embodiment constitutes a mother unit for the load bearing units 300.

The self-propelled adaptor unit 200 comprises two openings 250 in a side of its frame, the openings 250 in this embodiment constitutes two first mechanical connections which can interconnect whit the load bearing units 300 by placing the load bearing units 300 into the openings 250 of the self-propelled adaptor unit 200.

The self-propelled adaptor unit 200 further comprises a second mechanical connection 270, a motor, two drive wheels 220 and a computer according to the aforementioned embodiments of FIGS. 1A/1B and 2A/2B.

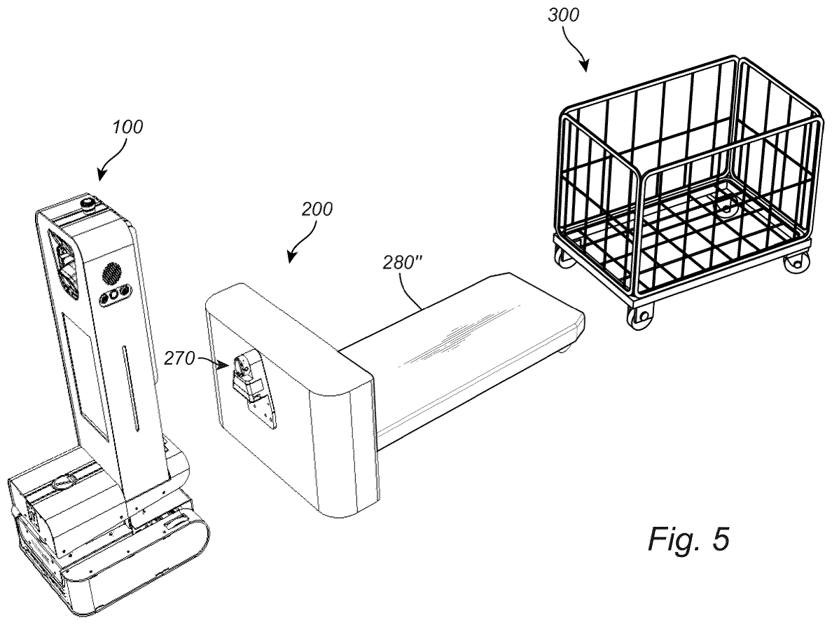

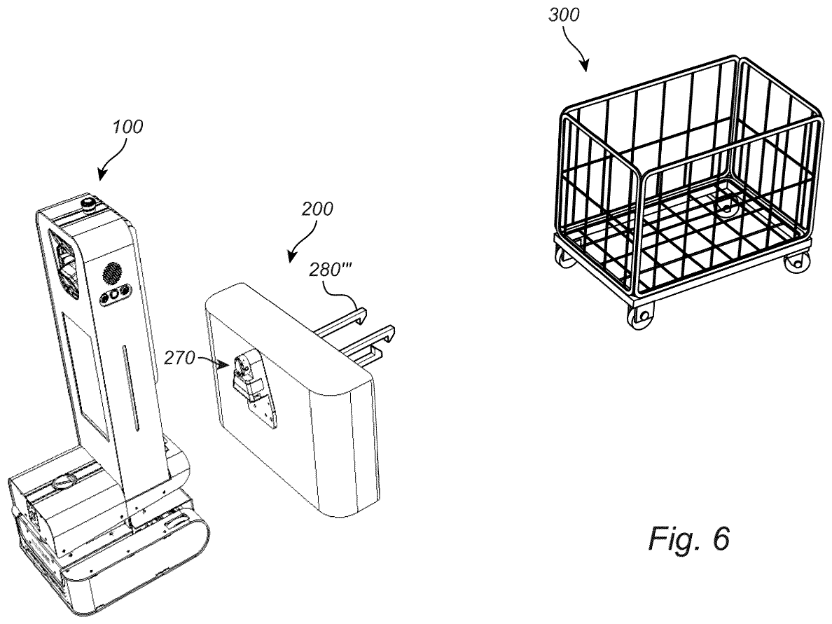

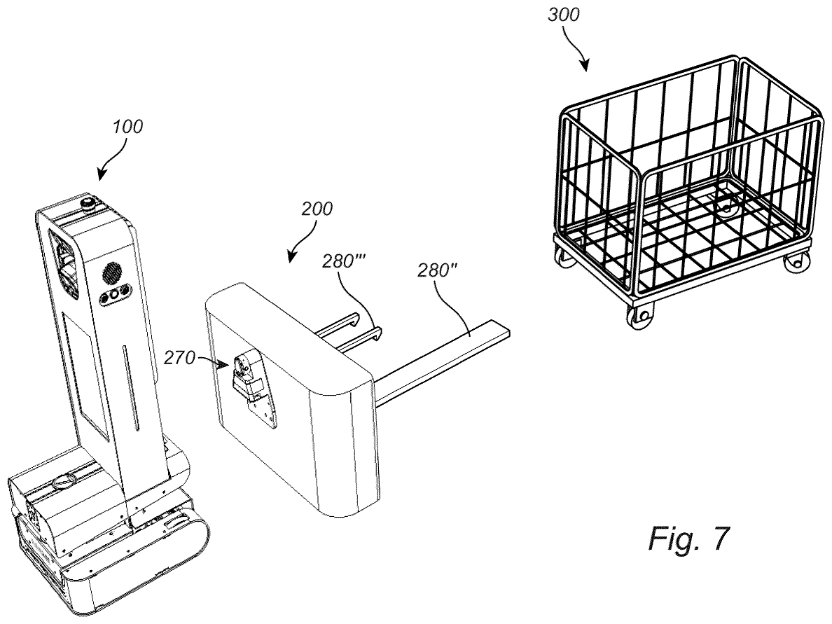

FIG. 5-7 show alternative embodiments of a system for intralogistics comprising a self-propelled autonomous or remote-controlled guide unit 100 according to the aforementioned embodiments, as well as a load bearing unit 300 and a self-propelled adaptor unit 200, wherein the load bearing unit 300 is a roller cage 300′ and the self-propelled adaptor unit 200 is configured to connecting to and moving and/or lifting the roller cage.

The self-propelled adaptor unit 200 comprises an actuator 241 for controlling a horizontally protruding element 280″ and/or one or more claws 280″′. The horizontally protruding element 280″ is configured to engage with the underside of the roller cage in order to lift the roller cage. The claws 280″′ are configured to engage with a side of a roller cage in order to clamp the side and lift the roller cage.

Further, one or more claws 280″′ may be combined with the horizontally protruding element 280″ to achieve clamping and bottom support function, thereby increasing stability of the system when moving and/or lifting the roller cage.

The self-propelled adaptor unit 200 further comprises a second mechanical connection 270, a motor, two drive wheels and a computer according to the aforementioned embodiments of FIGS. 1A/1B and 2A/2B.

FIG. 8a-c shows the self-propelled autonomous or remote-controlled guide unit 100 according to any one of the embodiments of FIG. 2A to FIG. 7.

FIG. 9 shows the self-propelled adaptor unit according to FIG. 3 illustrated with a cut out section to show internal parts of the self-propelled adaptor unit 200, such as the drive wheel 220, motor 230, and actuator 241.

FIG. 10 shows a self-propelled adaptor unit 200 according to the embodiment of FIG. 9 further comprising a forklift mast assembly 281.

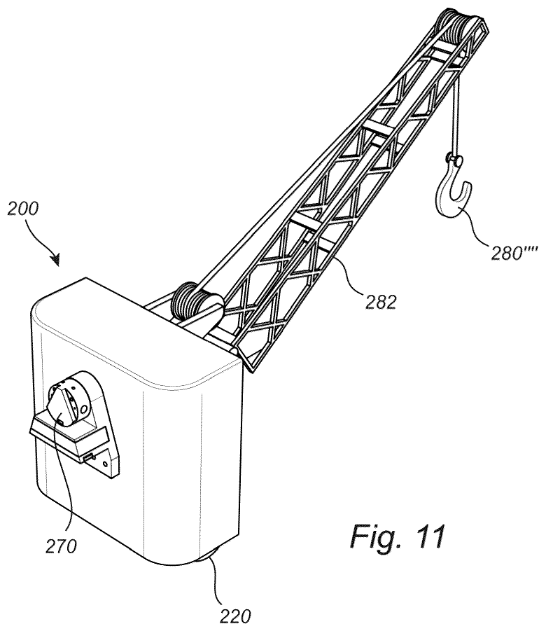

FIG. 11 shows a self-propelled adaptor unit 200 comprising a crane mast assembly 282, wherein the first mechanical connection 280″″ is configured as a crane element, such as a hook or mechanical grip tool.

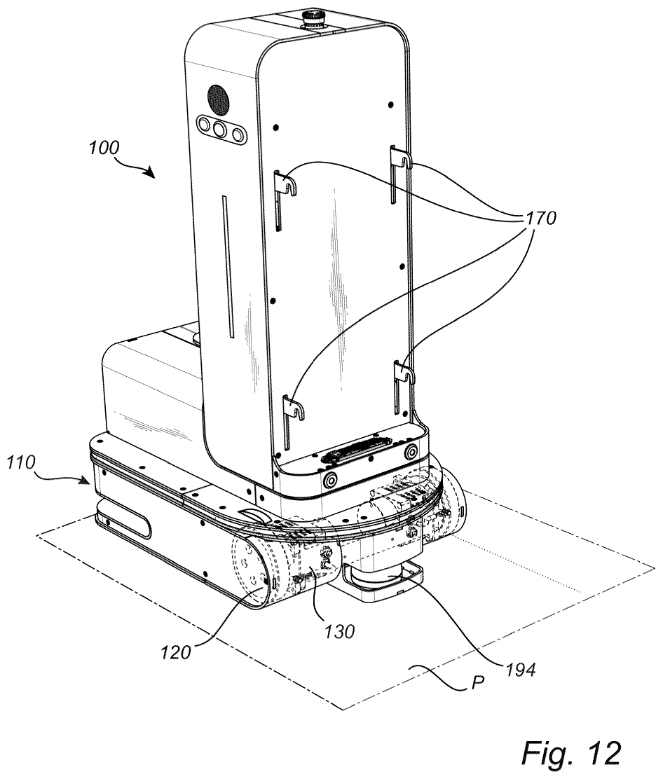

FIG. 12 shows a self-propelled autonomous or remote-controlled guide unit 100 comprising an alternative mechanical connection 170. In the embodiment shown in FIG. 12, the self-propelled autonomous or remote-controlled guide unit 100 comprises four engaging elements configured to engage corresponding engaging elements on the self-propelled adaptor unit 200. The engaging elements are connected to and operated by the actuator 141. The actuator is configured to actuate the engaging elements for moving the engagement elements downwards, lifting the self-propelled autonomous or remote-controlled guide unit 100 from the floor surface by the engagement between the engagement elements on the self-propelled autonomous or remote-controlled guide unit 100 and the corresponding engagement elements on the self-propelled adaptor unit 200. The actuator is configured to move the engaging elements in a strict vertical direction towards the floor surface, i.e. a direction being a normal to the plane of the floor surface. As such, the engaging elements carries a major portion of the weight of the self-propelled autonomous or remote-controlled guide unit 100, when lifted from the floor surface. However, in alternative embodiments, the actuator may be configured to move the engaging elements at an angle relative to the normal of the plane of the floor surface, such that the self-propelled autonomous or remote-controlled guide unit 100 may be lifted at an angle, e.g. an angle in range 0°-45° from relative to the normal of the plane of the floor surface. In such an embodiment, the lifting of self-propelled autonomous or remote-controlled guide unit 100 may be guided by an inclined plane connected to the self-propelled load bearing unit for supporting the lifting of the self-propelled autonomous or remote-controlled guide unit 100. The engaging elements on the self-propelled autonomous or remote-controlled guide unit 100 comprises a protrusion in the form of hooks configured to engage corresponding recesses comprising shafts suitable for engagement with the hooks. The hooks are configured to stabilize the self-propelled autonomous or remote-controlled guide unit 100 in at least a first, second and third direction. The self-propelled autonomous or remote-controlled guide unit 100 is configured to engage the self-propelled load bearing unit along the length axis LA, for positioning the self-propelled autonomous or remote-controlled guide unit 100 relative to the self-propelled adaptor unit 200 in a position enabling the connection between the self-propelled autonomous or remote-controlled guide unit 100 and self-propelled adaptor unit 200. The length axis LA being the axis along which the self-propelled autonomous or remote-controlled guide unit 100 travels in the final stages before engaging with the self-propelled adaptor unit 200. The length axis LA is parallel to the plane of the floor surface and thus perpendicular to the normal of the plane of the floor surface (perpendicular to the vertical direction towards the floor surface). The hooks are configured to stabilize the self-propelled autonomous or remote-controlled guide unit 100 in a first direction, being a direction of the engagement axis LA (the direction of protrusion of the hooks), a second direction being the direction opposite to the engagement axis LA, and a third direction being the direction of the normal to the plane of the floor surface, i.e. the direction supporting the weight from the self-propelled autonomous or remote-controlled guide unit 100 when it has been lifted from the floor surface.

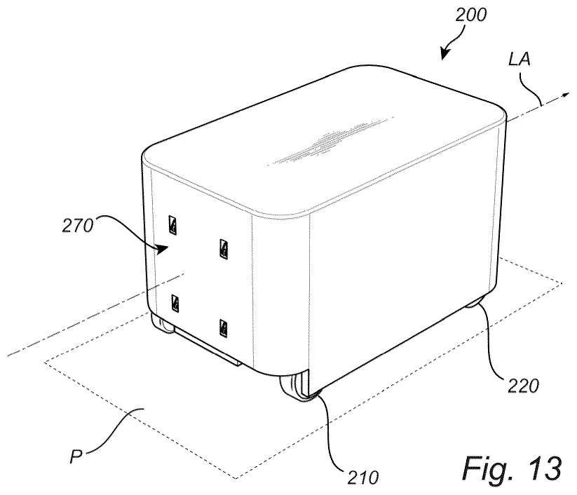

FIG. 13 shows a self-propelled adaptor unit 200 with the second mechanical connection of the adaptor unit corresponding to the mechanical connection of the guide unit of FIG. 12. The second mechanical connector 270 of the self-propelled adaptor unit 200 comprises four engagement elements in the form of four recesses for connection with the corresponding protrusions of the self-propelled autonomous or remote-controlled guide unit 100. The second mechanical connector 270 is configured to enable the self-propelled autonomous or remote-controlled guide unit 100 to be connected to the self-propelled adaptor unit 200. The second mechanical connector 270 is positioned in the front portion of the self-propelled adaptor unit 200 and facing such that the self-propelled autonomous or remote-controlled guide unit 100 will be positioned substantially centrally in front of the self-propelled adaptor unit 200, when self-propelled autonomous or remote-controlled guide unit 100 is connected to the self-propelled adaptor unit 200. The second mechanical connection 270 is configured to hold the weight of the self-propelled autonomous or remote-controlled guide unit 100 when it is lifted from the floor surface.

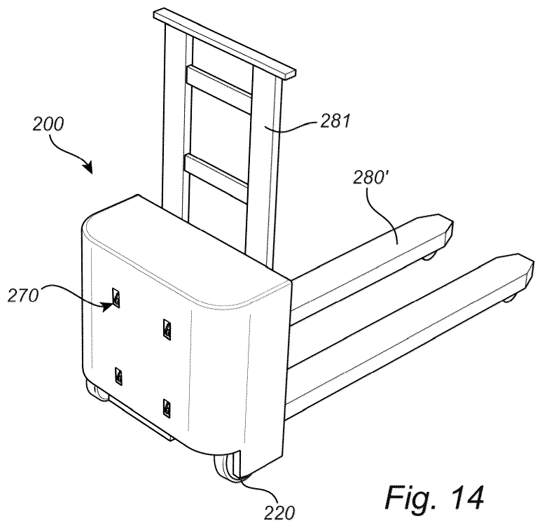

FIG. 14 shows the self-propelled adaptor unit 200 of FIG. 10 with the embodiment of the second mechanical connection 270 according to that of FIG. 13.

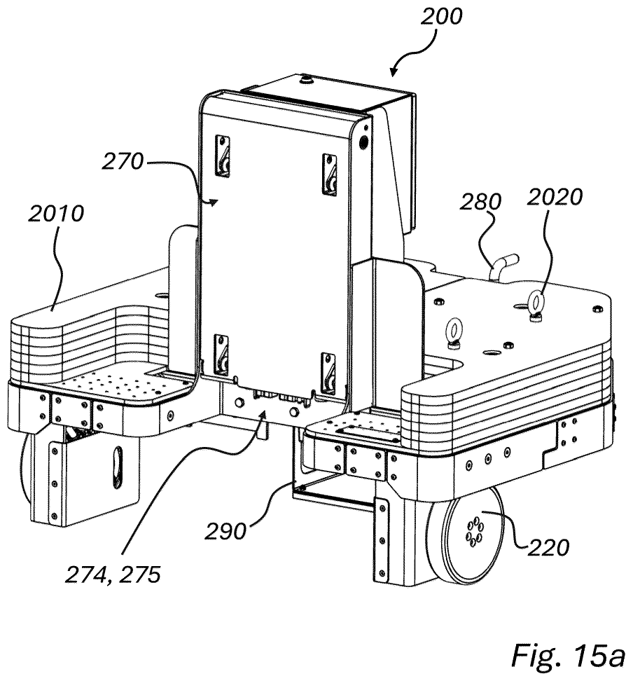

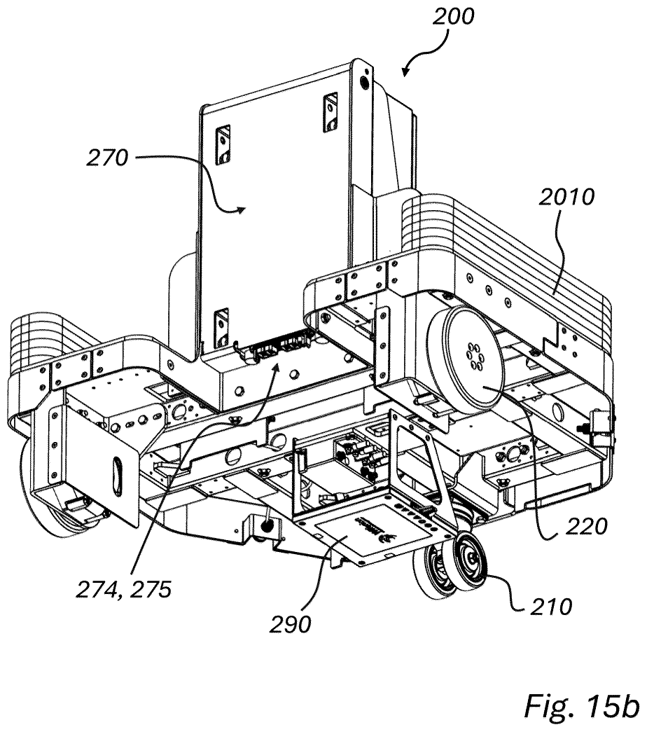

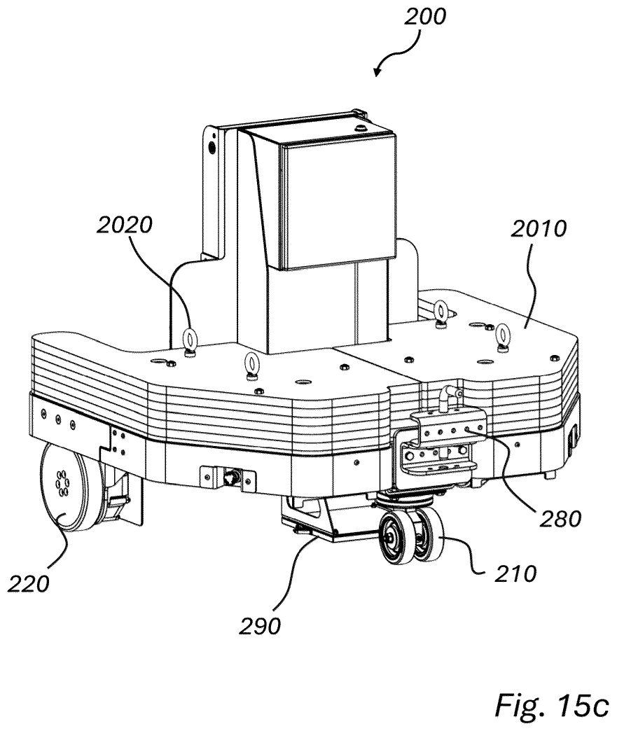

FIG. 15a-15c show an alternative design of a self-propelled adaptor unit 200. The adaptor unit 200 comprises a second mechanical connection 270 similar to the one of the adaptor unit of FIG. 13, which correspond to the mechanical connection of the guide unit of FIG. 12. In this embodiment, the self-propelled adaptor unit 200 comprises an alternative first mechanical connection 280, configured to connect to a mechanical connection of a load bearing unit 300, such that a first mechanical interconnection can be created between the self-propelled adaptor unit 200 and a load bearing unit 300. The first mechanical connection 280 of this embodiment is especially well suited for dragging a cart or the like, but may be used to connect to any type of load bearing unit 300 with a corresponding mechanical connection.

The self-propelled adaptor unit 200 further comprises an inductive charger 290 for inductively charging the energy source 190 of the self-propelled autonomous or remote-controlled guide unit 100 when the adaptor unit 200 and guide unit 100 is engaged in an electrical connection. The inductive charger 290 comprises an inductive receiver coil for receiving electrical energy from an inductive charging plate, or the like, comprising an inductive transmitting coil for transmitting the electrical energy to the inductive charger 290 of the self-propelled adaptor unit 200.

To inductively charge the energy source 190 of the guide unit 100, the adaptor unit 200 must place itself on or near an inductive charging plate in the intralogistics environment. Electrical energy will be transmitted from the transmitting coil of the inductive charging plate to the inductive receiver coil of the inductive charger 290. The electrical energy is then electrically conducted from the inductive charger 290 of the adaptor unit to the energy source 190 of the guide unit 100 via electrical wiring and the electrically connected electrical connections 274, 275 and 174, 175, and received by the energy source 190 of the guide unit 100.

The self-propelled adaptor unit 200 is also further equipped with a ballast load 2010, such as weight plates, to secure adequate weight of the adaptor unit 200 to securely break or accelerate when moving a heavy load bearing unit 300. The ballast load 2010 is fixedly secured to the adaptor unit 200, e.g., by eyebolts 2020, bolts or screws. The use of eyebolts 2020 provides the possibility of fastening other material the adaptor unit 200, and/or provides an easy and quick way to unscrew the eyebolts without specialised tools, for removing or changing the ballast load 2010, however any fastening means may be used.

The arrangement of a removable ballast load 2010 on the self-propelled adaptor unit 200 may provide an adaptor unit having a total weight that is 2, 3, 4, 5, 6, 7, 8, 9, 10, 11, 12, 13, 14, 15, 16, 17, 18, 19 or 20 times that of the total weight of the self-propelled autonomous or remote-controlled guide unit 100.

Please note that any aspect or part of an aspect as well as any method or part of method or any unit, feature or system could be combined in any applicable way if not clearly contradictory.

### NUMBERED EMBODIMENTS

In the following, exemplifying numbered embodiments are provided. The numbered embodiments are not to be seen as limiting the scope of the invention, which is defined by the appended embodiments. The reference numerals in the different numbered embodiments are to be seen only as examples of elements in the appended drawings which correspond to elements described in the numbered embodiments.

1. A system for intralogistics comprising:
a load bearing unit,
a self-propelled adaptor unit, and
a self-propelled autonomous or remote-controlled guide unit, wherein:
   the load bearing unit comprises:
a mechanical connection,
at least one support element configured to be placed at least partially in contact with a load, and at least one of:
at least one wheel enabling the load bearing unit to be rolled on a floor surface, and
the mechanical connection enabling the load bearing unit to be lifted from a floor surface by the self-propelled adaptor unit,
   the self-propelled adaptor unit comprises:
a motor, and
at least one drive wheel connected to the motor for propelling the self-propelled adaptor unit,
a first mechanical connection configured to connect to the mechanical connection of the load bearing unit, such that a first mechanical interconnection can be created between the self-propelled adaptor unit and the load bearing unit,
a computer connected to the motor, the computer comprises a receiver for receiving instructions from the self-propelled autonomous or remote-controlled guide unit for controlling the motor, and wherein the self-propelled adaptor unit is configured to at least one of:
push or pull the load bearing unit in a substantially horizontal direction, and lift the load bearing unit up or down,
   the self-propelled autonomous or remote-controlled guide unit comprises:
a motor, and
at least one drive wheel connected to the motor for propelling the self-propelled autonomous or remote-controlled guide unit, and
a computer comprising:
a transmitter for communicating with the receiver of the self-propelled adaptor unit,
a navigation system for navigating in an environment, and
at least one sensor for sensing objects in the environment, wherein:
   the computer of the self-propelled autonomous or remote-controlled guide unit is configured to generate control signals on the basis of input from the navigation system and the at least one sensor and transmit the control signals using the transmitter to the self-propelled adaptor unit for controlling the motor of the self-propelled adaptor unit.

2. The system according to embodiment 1, wherein:
the computer of the self-propelled adaptor unit comprises a transceiver, and wherein the receiver is part of the transceiver,
the computer of the self-propelled autonomous or remote-controlled guide unit comprises a transceiver, and wherein the transmitter is part of the transceiver, and
the computer of the self-propelled adaptor unit and the computer of the self-propelled autonomous or remote-controlled guide unit are configured to communicate with each other.

3. The system according to embodiment 1 or 2, wherein the self-propelled adaptor unit comprises a second mechanical connection, and the self-propelled autonomous or remote-controlled guide unit comprises a mechanical connection configured to connect to the second mechanical connection of the self-propelled adaptor unit, such that a second mechanical interconnection can be created between the self-propelled adaptor unit and the self-propelled autonomous or remote-controlled guide unit.

4. The system according to any one of embodiments 1-3, wherein the self-propelled autonomous or remote-controlled guide unit and the self-propelled adaptor unit each comprises an electrical connection, such that the self-propelled autonomous or remote-controlled guide unit can be electrically connected to the self-propelled adaptor unit.

5. The system according to embodiment 4, wherein the electrical connection of the self-propelled autonomous or remote-controlled guide unit and the self-propelled adaptor unit, is configured to transfer electrical energy for powering the motor of the self-propelled adaptor unit.

6. The system according to embodiment 5, wherein the self-propelled autonomous or remote-controlled guide unit comprises an energy source for powering the self-propelled adaptor unit.

7. The system according to any one of embodiments 4-6, wherein the electrical connection of the self-propelled autonomous or remote-controlled guide unit and the self-propelled adaptor unit is configured to transfer data.

8. The system according to any one of embodiments 2-7, wherein the transceivers of the self-propelled autonomous or remote-controlled guide unit and the self-propelled adaptor unit are wireless transceivers.

9. The system according to any one of embodiments 1-8, wherein the first mechanical connection of the self-propelled adaptor unit comprises at least one of a recess and a protrusion and the mechanical connection of the load bearing unit comprises at least one of a corresponding recess or protrusion for mechanical interconnection between the self-propelled adaptor unit and the load bearing unit.

10. The system according to any one of embodiments 3-9, wherein the second mechanical connection of the self-propelled adaptor unit comprises at least one of a recess and a protrusion and the mechanical connection of the self-propelled autonomous or remote-controlled guide unit comprises at least one of a corresponding recess or protrusion for mechanical interconnection between the self-propelled adaptor unit and the self-propelled autonomous or remote-controlled guide unit.

11. The system according to any one of embodiments 2-10, wherein the self-propelled adaptor unit further comprises at least one sensor, and wherein the transceiver of the self-propelled adaptor unit is configured to transmit sensor data to the transceiver of the self-propelled autonomous or remote-controlled guide unit.

12. The system according to embodiment 11, wherein the self-propelled autonomous or remote-controlled guide unit is configured to generate control signals on the basis of the received sensor data.

13. The system according to any one of embodiments 11 and 12, wherein the self-propelled adaptor unit comprises at least one of a sensor selected from a list consisting of pressure sensors, motion sensors and Lidar.

14. The system according to any one of the embodiments 1-13, wherein the self-propelled autonomous or remote-controlled guide unit is configured to be placed at least partially under the self-propelled adaptor unit.

15. The system according to any one of the embodiments 1-14, wherein the at least one support element of the load bearing unit is configured for supporting a Euro-pallet.

16. The system according to any one of the embodiments 1-15, wherein the first mechanical connection of the self-propelled adaptor unit is configured for supporting a Euro-pallet.

17. The system according to any one of the embodiments 1-16, wherein the self-propelled adaptor unit further comprises an actuator for lifting the load bearing unit up or down.

18. The system according to embodiment 17, wherein the actuator comprises a forklift mast assembly and the first mechanical connection of the self-propelled adaptor unit is comprised as part of the forklift mast assembly.

19. The system according to embodiment 17, wherein the actuator comprises a crane mast assembly and the first mechanical connection of the self-propelled adaptor unit is comprised as part of the crane mast assembly.

20. The system according to any one of the embodiments 1-19, wherein the first mechanical interconnection is configured to fixate the self-propelled adaptor unit to the load bearing unit both in a direction of a length axis (LA) of the self-propelled adaptor unit and in a direction perpendicular to the length axis (LA) of the self-propelled adaptor unit.

21. The system according to any one of the embodiments 1-20, wherein the second mechanical interconnection is configured to fixate the self-propelled autonomous or remote-controlled guide unit to the self-propelled adaptor unit both in a direction of a length axis (LA) of the self-propelled adaptor unit and in a direction perpendicular to the length axis (LA) of the self-propelled adaptor unit.

22. The system according to any one of the preceding embodiments, wherein the self-propelled adaptor unit comprises an optical sensor configured to sense a mobile optical marker within a sensor area.

23. The system according to any one of the preceding embodiments, wherein the self-propelled adaptor unit is configured to move a load of least one of: 100 kg, 1000 kg and 5000 kg.

24. The system according to any one of the preceding embodiments, wherein the self-propelled autonomous or remote-controlled guide unit is placed and control the self-propelled adaptor unit at a distance from the load bearing unit, such that the self-propelled adaptor unit is located between the self-propelled autonomous or remote-controlled guide unit and the load bearing unit.

25. The system according to any one of the preceding embodiments, wherein the self-propelled autonomous or remote-controlled guide unit comprises at least two times the computing power of the self-propelled adaptor unit, wherein computing power is defined by one of RAM, instructions per second, clock speed (Ghz), and bits.

26. The system according to any one of the preceding embodiments, wherein the motor of the self-propelled adaptor unit comprises at least two times the motor power compared to the motor of the self-propelled autonomous or remote-controlled guide unit.

27. The system according to any one of the preceding embodiments, comprising at least two self-propelled adaptor units, wherein the at least two self-propelled adaptor units comprise a first self-propelled adaptor unit configured to fulfil a first purpose and a second self-propelled adaptor unit configured to fulfil a second purpose, wherein the first purpose and the second purpose are different.

28. The system according to embodiment 27, wherein the first purpose is connecting to and lifting a load bearing unit, and the second purpose is to connect to and move a wheeled cart.

29. The system according to any one of the embodiments 1-26, comprising at least two self-propelled adaptor units, wherein the at least two self-propelled adaptor units comprise a first self-propelled adaptor unit configured to connect to the mechanical connection of a first type of load bearing unit, and a second self-propelled adaptor unit configured to connect to the mechanical connection of a second type of load bearing unit.

30. The system according to embodiment 29, wherein the first type of load bearing unit is a pallet, and the second type of load bearing unit is a wheeled cart.

31. The system according to any one of the preceding embodiments, wherein the self-propelled adaptor unit comprises a main body, and the motor is comprised within the main body.

32. The system according to embodiments 31, wherein the first mechanical connection is arranged on a first side of the main body and at least one of:
protruding outwards in a direction transversal to the first side of the main body, and
recessing inwards in a direction transversal to the first side of the main body.

33. The system according to any one of the embodiments 31 or 32, wherein the first side of the main body has an angle of between 5 to 90 degrees measured from a completely horizontal plane.

34. The system according to any one of the embodiments 1 to 16 and 20 to 33, wherein the first mechanical connection of the self-propelled adaptor unit is connected to an actuator and is configured to engage with and lift a roller cage.

35. The system according to embodiment 34, wherein the first mechanical connection comprises at least one horizontally protruding element configured to engage with the underside of a roller cage in order to lift the roller cage.

36. The system according to embodiment 34 or 35, wherein the first mechanical connection comprises at least two claws configured to engage with a side of a roller cage in order to clamp the side and lift the roller cage.

37. The system according to embodiment 34, wherein the first mechanical connection comprises at least one horizontally protruding element configured to engage with the underside of a roller cage and at least one claw configured engage with a side of a roller cage, wherein the at least one horizontally protruding element and at least one claw are configured to clamp the roller cage, such that it can be lifted and/or moved.

38. A self-propelled adaptor unit for use in an intralogistics system according to any one of the preceding embodiments, the self-propelled adaptor unit comprising:
a motor, and
at least one drive wheel connected to the motor for propelling the self-propelled adaptor unit,
a first mechanical connection configured to connect to a mechanical connection of a load bearing unit, such that a first mechanical interconnection can be created between the self-propelled adaptor unit and the load bearing unit,
a computer connected to the motor and the at least one drive wheel, the computer comprises a receiver for receiving instructions from a self-propelled autonomous or remote-controlled guide unit for controlling the motor, and wherein the self-propelled adaptor unit is configured to at least one of:
push or pull the load bearing unit in a substantially horizontal direction, and
lift the load bearing unit up or down.

39. The self-propelled adaptor unit according to embodiment 38, wherein the computer comprises a transceiver, and wherein the receiver is part of the transceiver, and wherein the computer is configured to communicated with a computer of the self-propelled autonomous or remote-controlled guide unit.

40. The self-propelled adaptor unit according to embodiment 38 or 39, further comprising a second mechanical connection, configured to connect to a mechanical connection of the self-propelled autonomous or remote-controlled guide unit, such that a second mechanical interconnection can be created between the self-propelled adaptor unit and the self-propelled autonomous or remote-controlled guide unit.

41. The self-propelled adaptor unit according to any one of embodiments 38 to 40, further comprising an electrical connection, such that the self-propelled adaptor unit can be electrically connected to the self-propelled autonomous or remote-controlled guide unit.

42. The self-propelled adaptor unit according to embodiment 41, wherein the electrical connection is configured to transfer electrical energy for powering the motor.

43. The self-propelled adaptor unit according to embodiment 41 or 42, wherein the electrical connection is configured to transfer data.

44. The self-propelled adaptor unit according to any one of embodiments 39 to 43, wherein the transceiver is a wireless transceiver.

45. The self-propelled adaptor unit according to any one of embodiments 38 to 44, wherein the first mechanical connection comprises at least one of a recess and a protrusion corresponding to at least one of a recess and a protrusion of the load bearing unit for mechanical interconnection between the self-propelled adaptor unit and the load bearing unit.

46. The self-propelled adaptor unit according to any one of embodiments 40 to 45, wherein the second mechanical connection comprises at least one of a recess and a protrusion corresponding to at least one of a recess and a protrusion of the self-propelled autonomous or remote-controlled guide unit for mechanical interconnection between the self-propelled adaptor unit and the self-propelled autonomous or remote-controlled guide unit.

47. The self-propelled adaptor unit according to embodiments 39 to 46, further comprising at least one sensor, and wherein the transceiver is configured to transmit sensor data to the transceiver of the self-propelled autonomous or remote-controlled guide unit.

48. The self-propelled adaptor unit according to embodiments 47, wherein the at least one sensor is selected from a list consisting of pressure sensors, motion sensors and Lidar.

49. The self-propelled adaptor unit according to any one of the embodiments 38 to 48, further comprising an actuator for lifting the load bearing unit up or down.

50. The self-propelled adaptor unit according to embodiment 49, wherein the actuator comprises a forklift mast assembly and the first mechanical connection is comprised as part of the forklift mast assembly.

51. The self-propelled adaptor unit according to embodiment 49, wherein the actuator comprises a crane mast assembly and the first mechanical connection is comprised as part of the crane mast assembly.

52. The self-propelled adaptor unit according to any one of the embodiments 38 to 51, wherein the first mechanical interconnection is configured to fixate the self-propelled adaptor unit to the load bearing unit both in a direction of a length axis (LA) of the self-propelled adaptor unit and in a direction perpendicular to the length axis (LA) of the self-propelled adaptor unit.

53. The self-propelled adaptor unit according to any one of the embodiments 38 to 52, wherein the second mechanical interconnection is configured to fixate the self-propelled autonomous or remote-controlled guide unit to the self-propelled adaptor unit both in a direction of a length axis (LA) of the self-propelled adaptor unit and in a direction perpendicular to the length axis (LA) of the self-propelled adaptor unit.

54. The self-propelled adaptor unit according to any one of embodiments 38 to 53, comprising an optical sensor configured to sense a mobile optical marker within a sensor area.

55. The self-propelled adaptor unit according to any one of embodiments 38 to 54, configured to move a load of least one of: 100 kg, 1000 kg and 5000 kg.

56. A connection system for connecting a self-propelled autonomous or remote-controlled guide unit to a self-propelled adaptor unit, the self-propelled autonomous or remote-controlled guide unit being configured to guide the self-propelled adaptor unit for moving on the floor surface when the self-propelled autonomous or remote-controlled guide unit and the self-propelled adaptor unit are connected, the connection system comprising:
a first recess or protrusion on the self-propelled autonomous or remote-controlled guide unit comprising a load bearing portion
a second recess or protrusion on the self-propelled adaptor unit,
a first electrical connector on the self-propelled autonomous or remote-controlled guide unit, and
a second electrical connector on the self-propelled adaptor unit, wherein
the first recess or protrusion is configured to engage the second recess or protrusion for mechanically connecting the self-propelled autonomous or remote-controlled guide unit to the self-propelled adaptor unit and the first and second electrical connectors are configured to be connected for electrically connecting the self-propelled autonomous or remote-controlled guide unit to the self-propelled adaptor unit, wherein the connection system further comprises:
an actuator configured to move at least one of the first recess or protrusion and the second recess or protrusion for engaging the first recess or protrusion to the second recess or protrusion, and wherein at least one of the first and second electrical connectors are configured to be actuated for connecting the first electrical connector to the second electrical connector, and
a control unit for controlling the actuation of:
   at least one of the first recess or protrusion and the second recess or protrusion, and
   at least one of the first and second electrical connector, wherein
the control unit is configured to control the actuation such that the first recess or protrusion engages the second recess or protrusion before the first electrical connector engages the second electrical connector, such that the actuation of at least one of the first recess or protrusion and the second recess or protrusion aligns the first electrical and the second electrical connector before the first electrical connector engages the second electrical connector.

57. A connection system according to embodiment 56, wherein the actuation of one of at least the first and second electrical connectors are actuated by the actuator comprised by the connection system.

58. A connection system according to embodiment 56, wherein the actuation of one of at least the first and second electrical connectors are actuated by a second actuator comprised by the connection system.

59. The connection system according to any one of embodiment 56 to 58, wherein the first recess or protrusion on the self-propelled autonomous or remote-controlled guide unit comprises a protrusion.

60. The connection system according to any one of embodiment 56 to 59, wherein the second recess or protrusion on the self-propelled adaptor unit comprises a recess.

61. The connection system according to any one of the preceeding embodiments, wherein the first recess or protrusion on the self-propelled autonomous or remote-controlled guide unit comprises a set of protrusions and one recess.

62. The connection system according to any one of the preceeding embodiments, wherein the second recess or protrusion on the self-propelled adaptor unit comprises a set of recesses and one protrusion.

63. The connection system according to any one of the preceeding embodiments, wherein the first recess or protrusion is configured to engage the second recess or protrusion in a two step process, by first abutting the first and second recess or protrusions in a horizontal direction and subsequently moving the first recess or protrusion in a vertical direction to engage the second recess or protrusion.

64. The connection system according to embodiment 63, wherein the vertical direction is a movement of the first recess or protrusion in a direction towards the floor surface.

The different aspects or any part of an aspect of the different numbered embodiments or any part of an embodiment may all be combined in any possible way. Any method embodiment or any step of any method embodiment may be seen also as an apparatus description, as well as any apparatus embodiment, aspect or part of aspect or part of embodiment may be seen as a method description and all may be combined in any possible way down to the smallest detail. Any detailed description should be interpreted in its broadest outline as a general summary description.

1. A system for intralogistics comprising:
a load bearing unit,
a self-propelled adaptor unit, and
a self-propelled autonomous or remote-controlled guide unit, wherein:
the load bearing unit comprises:
a mechanical connection,
at least one support element configured to be placed at least partially in contact with a load, and at least one of:
at least one wheel enabling the load bearing unit to be rolled on a floor surface, and
the mechanical connection enabling the load bearing unit to be lifted from a floor surface by the self-propelled adaptor unit,
the self-propelled adaptor unit comprises:
a motor, and
at least one drive wheel connected to the motor for propelling the self-propelled adaptor unit,
a first mechanical connection configured to connect to the mechanical connection of the load bearing unit, such that a first mechanical interconnection can be created between the self-propelled adaptor unit and the load bearing unit,
a computer connected to the motor, the computer comprises a receiver for receiving instructions from the self-propelled autonomous or remote-controlled guide unit for controlling the motor, and wherein the self-propelled adaptor unit is configured to at least one of:
push or pull the load bearing unit in a substantially horizontal direction, and lift the load bearing unit up or down,
the self-propelled autonomous or remote-controlled guide unit comprises:
a motor, and
at least one drive wheel connected to the motor for propelling the self-propelled autonomous or remote-controlled guide unit, and
a computer comprising:
a transmitter for communicating with the receiver of the self-propelled adaptor unit,
a navigation system for navigating in an environment, and
at least one sensor for sensing objects in the environment, wherein:
the self-propelled autonomous or remote-controlled guide unit has less load bearing/pulling capabilities than the self-propelled adaptor unit,
the motor(s) of the self-propelled adaptor unit is configured to generate more torque than the motor(s) of the self-propelled autonomous or remote-controlled guide unit, and
the computer of the self-propelled autonomous or remote-controlled guide unit is configured to generate control signals on the basis of input from the navigation system and the at least one sensor and transmit the control signals using the transmitter to the self-propelled adaptor unit for controlling the motor of the self-propelled adaptor unit.
